(19) United States
(12) Patent Application Publication
(10) Pub. No.: US 2026/0104931 A1
(43) Pub. Date: Apr. 16, 2026

(54) OPTIMIZED RESOURCE ALLOCATION USING MULTI-LEVEL REGRESSION MODELING

(71) Applicant: Optum Services (Ireland) Limited, Dublin (IE)

(72) Inventors: Lisa E. Walsh, Dublin (IE); Daniel James Kelly, Dublin (IE); Conor John Waldron, Dublin (IE); Leo Finbar Kavanagh, Dublin (IE); Breanndán O Conchuir, Kerry (IE)

(21) Appl. No.: 18/916,909

(22) Filed: Oct. 16, 2024

(51) Int. Cl. G06F 9/50

(52) U.S. Cl. CPC G06F 9/5027

(57) ABSTRACT

Various embodiments of the present disclosure provide a optimized resource allocation using multi-level regression modeling that improves the functionality of a computer in various aspects. The techniques comprise synthesizing (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class. The techniques additionally comprise applying the multi-level regression model to a target cohort within a requested geographic location to generate a composite reward score for the requested geographic location, wherein the composite reward score combines a reward score for each probability classification of the plurality of defined probability classifications for the requested class.

### BACKGROUND

Various embodiments of the present disclosure address technical challenges related geographic resource allocation and mapping systems and, more particularly, data modeling and scaling techniques leveraged by geographic resource allocation and mapping systems. In many domains, the allocation of limited resources (e.g., time, focus, objects) across different geographic locations, separated by travel times within a mapping system, require accurate predictions of data characteristics from limited sample data. However, traditional modeling and/or data scaling techniques rely on simplistic extrapolation of data that fail to account for complex relationships between data and/or sampling biases.

Traditionally, resource allocation and mapping systems utilize simplistic, rule-based data scaling techniques to augment different geographic regions within a mapping interface with data metrics extrapolated from a limited dataset for only a subset of the geographic regions. Such techniques rely on faulty assumptions that a particular characteristic observed in the limited dataset may be directly extrapolated to a full dataset. By doing so, these techniques produce inaccurate results that fail to model nuanced relationship between different geographic regions and the limited dataset. In some cases, post-stratification techniques are applied to address these technical challenges by adjusting predictions for known data discrepancies. However, traditional post-stratification modeling techniques are resource intensive, which prevents their use within an interactive mapping interface. Moreover, even overlooking the resource expense of post-stratification techniques, such techniques still struggle to capture nuanced relationships and/or interactions between multiple data variables.

Various embodiments of the present disclosure make important contributions to resource allocation and mapping technologies as well as the data modeling and scaling techniques leveraged by such technologies by addressing these technical challenges, among others.

### BRIEF DESCRIPTION OF THE DRAWINGS

FIG. 1 depicts an example overview of an architecture in accordance with some embodiments of the present disclosure.

FIG. 2 depicts an example predictive data analysis computing entity in accordance with some embodiments of the present disclosure.

FIG. 3 depicts an example client computing entity in accordance with some embodiments of the present disclosure.

FIG. 4 depicts a dataflow diagram showing example data structures, modules, and/or pipelines for training a multi-level regression model in accordance with some embodiments of the present disclosure.

FIG. 5 depicts a dataflow diagram showing example data structures, modules, and/or pipelines for utilizing a trained multi-level regression model in accordance with some embodiments of the present disclosure.

FIG. 6 depicts a dataflow diagram showing example data structures, modules, and/or pipelines for performing a multi-level regression modeling process in accordance with some embodiments of the present disclosure.

FIG. 7 depicts an interactive map-based visualization system showing example devices, systems, engines, data structures, and/or processes for generating a routing overlay for rendering via a user interface in accordance with some embodiments of the present disclosure.

FIG. 8 depicts a resource manufacturing device management system showing example devices, systems, engines, data structures, and/or processes for generating a routing overlay for rendering via a user interface in accordance with some embodiments of the present disclosure.

FIG. 9 depicts an example plurality of defined probability classifications for a requested class in accordance with some embodiments of the present disclosure.

FIG. 10 depicts an example entity stratification table in accordance with some embodiments of the present disclosure.

FIG. 11 depicts a dataflow diagram showing example data structures, modules, and/or pipelines for training a multi-level regression model in accordance with some embodiments of the present disclosure.

FIG. 12 depicts an example prediction output provided by a multi-level regression model in accordance with some embodiments of the present disclosure.

FIG. 13 depicts an example system for providing prediction-based actions and/or visualizations in accordance with some embodiments of the present disclosure.

FIG. 14 depicts example user interface in accordance with some embodiments of the present disclosure.

FIG. 15 depicts a flowchart diagram of example process for training and/or deploying a multi-level regression model in accordance with some embodiments of the present disclosure.

### DETAILED DESCRIPTION

Various embodiments of the present disclosure provide optimized resource allocation and mapping systems that leverage improved data modeling and scaling techniques to enable interactive mapping interfaces reflective of dense geographic characteristics. In various embodiments, the dense geographic characteristics comprise composite reward scores for geographic locations that are generated through a multi-level regression model pipeline that synthesizes prediction stratification data with entity feature vectors stored in association with a set of geographic locations represented by the interactive mapping interface. To overcome performance deficiencies with traditional rule-based and post stratification techniques, the multi-level regression model of the present disclosure synthesizes probability classifications for individuals within a limited dataset with class stratifications to scale reward scores across the set of geographic regions based on the individual features of the individuals within the set of geographic regions as well as the interactions between these features. In this way, the multi-level regression model pipeline of the present disclosure allows for feature-level scaling that addresses various technical deficiencies of tradition geographic scaling techniques. When applied within a digital mapping environment, the feature-level scaling techniques enable improved mapping interfaces that may be leveraged to automate various geographic-based actions.

In some embodiments, the feature-level scaling provided by the multi-level regression model pipeline enables bias correction functions within a scaling framework that has traditionally been outside the scope of large mapping systems. For instance, the multi-level regression model pipeline may be configured to learn relationships between probability classifications, class stratifications, and the features of individuals within the class stratifications through an analysis of a limited dataset. To account for biases in the multi-level regression model pipeline, underrepresented features within the limited dataset may be identified and adjusted. This allows the multi-level regression model pipeline to be leveraged to account for underrepresented features within the limited dataset. By doing so, the multi-level regression model pipeline addresses several technical challenges unique to computers that traditionally learn, rather than compensate for data biases. By implementing the multi-level regression model pipeline with limited datasets, where data biases are more prevalent, the multi-level regression model pipeline may improve both the performance and longevity of data modeling and scaling techniques implemented within a digital mapping environment.

In some embodiments, the multi-level regression model pipeline is integrated within a mapping interface to enable interactive actions grounded by feature-level scaling insights. By way of example, the multi-level regression model pipeline may be applied to a set of geographic locations represented by a mapping interface to generate composite reward scores that are directly comparable across geographic locations. By doing so, the multi-level regression model pipeline may surface individual values, from dense feature-level data, that may be efficiently processed with limited computing resources (e.g., within a client-side mapping interface) to augment a mapping interface in accordance with user input. The mapping interface, for example, may leverage the composite reward scores to generate dynamic optimized routes for users of a client device that may be modified responsive to user input. In this way, the multi-level regression model pipeline integrated within the mapping interface may enable real time routing, resource allocation, and/or automated actions without sacrificing the predictive accuracy of geographic insights that are traditionally diluted through stratification techniques.

In some embodiments, improved data pre-processing techniques for modeling are provided to improve input data and/or matching operations in high-dimensional computing systems that utilize modeling. By doing so, the data pre-processing may enable improved modeling processes that, when executed on a computer, improve computing resources and/or functionality of a computer with respect to various computing tasks, including model training, network communication, user interface rendering, and/or the like. In some embodiments, a data processing pipeline that utilizes machine learning to ingest, aggregate, manage, and/or transform data from data sources is provided. In some embodiments, the data processing pipeline intelligently configures data for a particular modeling task such as a multi-level regression task and/or an API task for an electronic interface. The resulting data provided by the modeling task may then be contextualized and/or formatted for rendering via an interactive electronic interface rendering. This, in turn, enables improved data pre-processing for a model that directly addresses technical challenges within the realm of traditional data processing techniques, such as time-consuming ingestion of data, resource intensive transformation of data, and/or inaccurate datasets for modeling tasks, among others.

In an example related to a healthcare technology domain, some embodiments provide optimized allocation of pharmaceutical resources by correlating a disease stratification table to a plurality of demographic-level tables respectively corresponding to a plurality of patients, generating a multi-level regression model based on the linked disease stratification tables, generating demographic-based disease prevalence scores using the multi-level regression model, generating location-specific disease prevalence scores based on a combination of population data for a location and the demographic-based disease prevalence scores, and/or optimizing pharmaceutical resources based on the location-specific disease prevalence scores.

Ultimately, various embodiments of the present disclosure improve the performance of resource allocation by enabling more precise and/or data-driven predictions. This, in turn, enables optimized prediction-based actions that, unlike traditional techniques, account for nuanced feature-level characteristics within a limited dataset for different geographic locations. For example, by utilizing improved multi-level regression modeling and advanced data scaling techniques, more accurate predictions of population-level characteristics from limited sample data may be provided, facilitating improved resource optimization across geographic locations.

Examples of technologically advantageous embodiments of the present disclosure comprise (i) improved mapping interfaces, (ii) improved data modeling and scaling frameworks, (iii) improved bias correction techniques, (iv) data processing techniques such as data pre-processing techniques for improving data formatting of input data for modeling, (v) multi-level regression modeling techniques for optimizing a data object for a rendering of a data visualization via a user interface, (vi) multi-level regression modeling techniques for optimizing a data object for optimizing configuration of a computing device such as a manufacturing device (e.g., a resource manufacturing device), (vii) improved multi-level regression models, and training techniques thereof, for generating mapping interfaces and/or configuring computing devices, (viii) and improved data visualizations by intelligently applying bias corrections and data modeling to data stored in disparate data sources, among other aspects of the present disclosure. Other technical improvements and advantages may be realized by one of ordinary skill in the art.

### I. OVERVIEW OF EMBODIMENTS

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

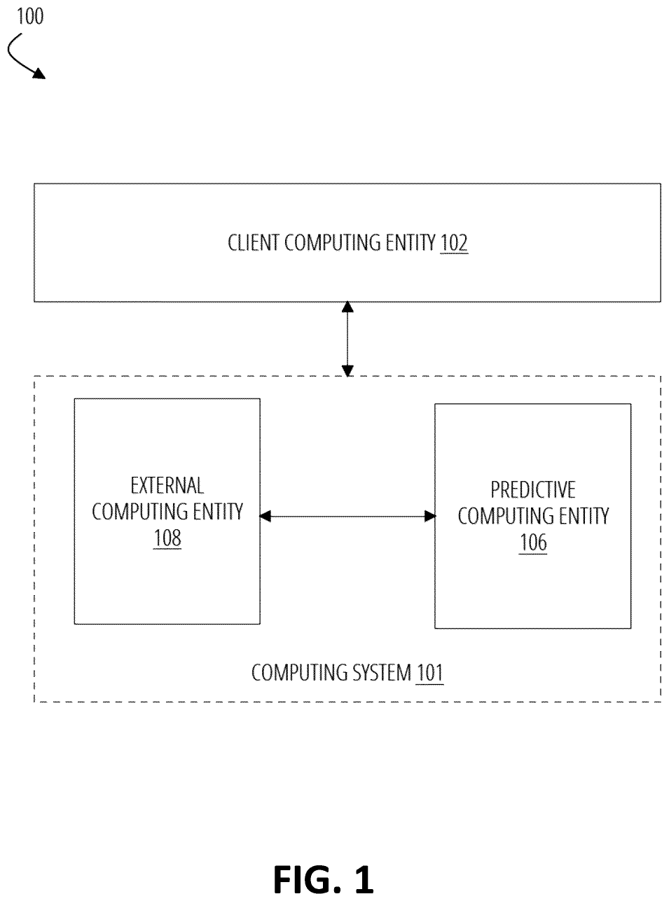

FIG. 1 depicts an example overview of an architecture 100 in accordance with some embodiments of the present disclosure. The architecture 100 comprises a computing system 101 configured to receive a request, such as a mapping request, a multi-level regression modeling request, a model ensemble prompt request, and/or the like, from client computing entities 102, process the request, and provide one or more responses, such as model output, prediction output, a data visualization, a user interface overlay, a routing overlay that identifies a user route, one or more graphical elements, and/or the like to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate candidate outputs, candidate output scores, and/or other machine learned outputs. The models may be adapted to a differential request handling engine and/or complementary scoring mechanism that may collectively process a request using data scaling and/or data pre-processing. Some techniques of the present disclosure may adapt traditional models to a cohesive modeling framework for more efficiently handling portions of the request handling process.

In some embodiments, the computing system 101 communicates with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate multi-level regression models in accordance with one or more training and/or inference operations of the present disclosure. In some examples, the external computing entities 108 may be configured to train, implement, use, update, and evaluate multi-level regression models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., request handling, multi-level regression modeling techniques scoring techniques, etc.) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as one or more recorded entity cohorts and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained model trained and subsequently provided by the one or more external computing entities 108. For example, the one or more external computing entities 108 may be configured to perform one or more training steps/operations of the present disclosure to train a model, as described herein. In such a case, the trained model may be provided to the predictive computing entity 106, which may leverage the trained model to perform one or more inference steps/operations of the present disclosure. In some examples, feedback (e.g., evaluation data, ground truth data) from the use of the model may be received and/or stored by the predictive computing entity 106. In some examples, the feedback may be provided to the one or more external computing entities 108 to continuously train the model over time. In some examples, the feedback may be leveraged by the predictive computing entity 106 to continuously train the model over time. In this manner, the computing system 101 may perform, via one or more combinations of computing entities, one or more prediction, training, and/or any other modeling techniques of the present disclosure.

### A. Example Predictive Computing Entity

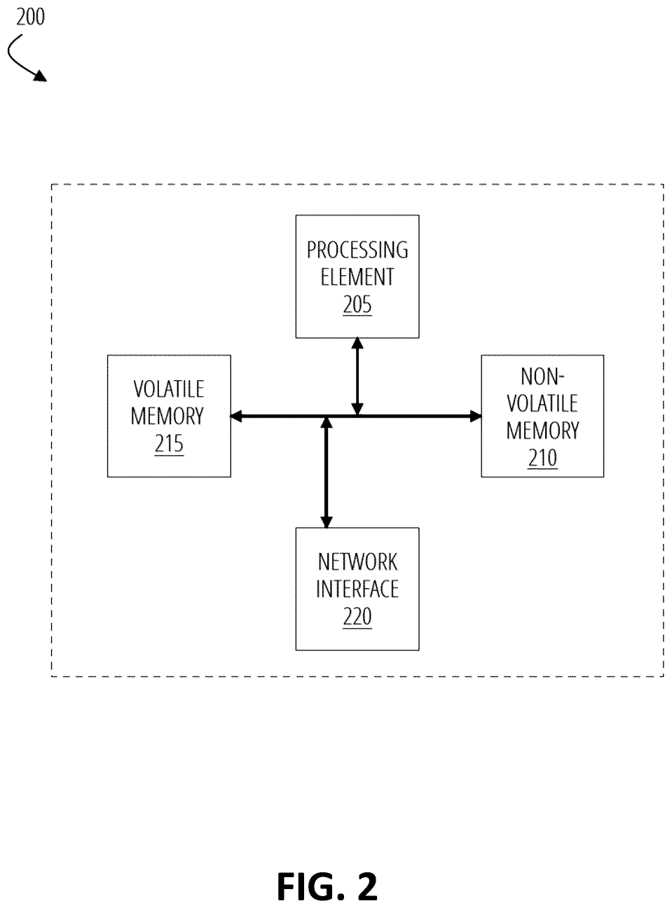

FIG. 2 depicts an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably) and/or volatile memory 215 (also referred to as volatile media, storage, memory storage, memory circuitry, and/or similar terms used herein interchangeably), as discussed above.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As will be recognized, the non-volatile memory 210 and/or the volatile memory 215 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may in addition or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may in addition or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

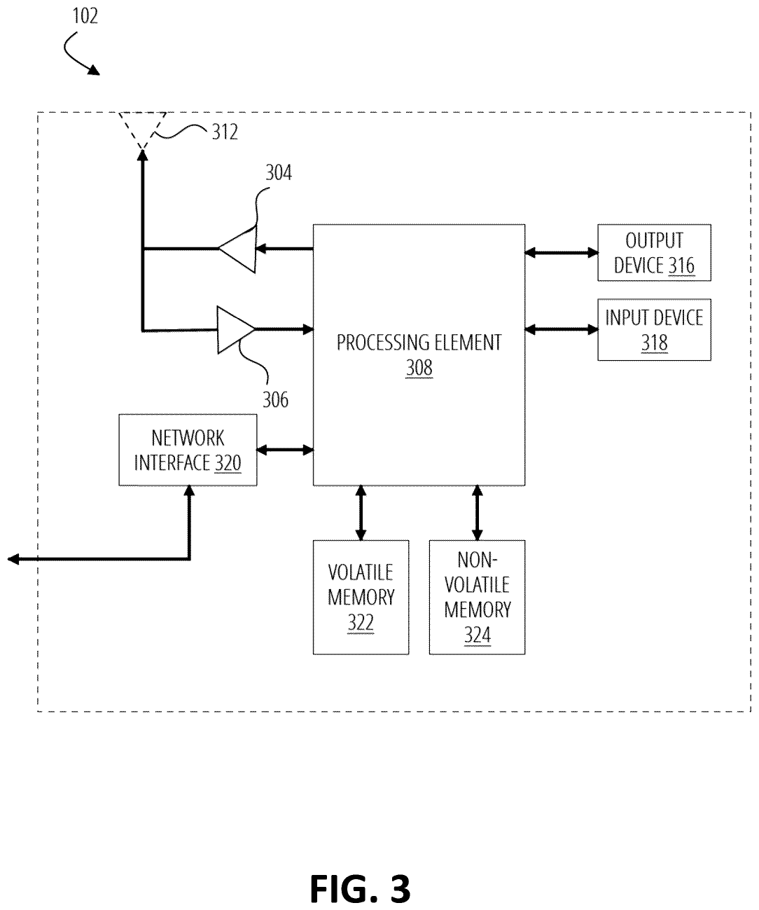

FIG. 3 depicts an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may in addition or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may in addition or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to optimizing resource allocation and mapping systems by providing improved data modeling and scaling techniques to enable interactive mapping interfaces reflective of dense geographic characteristics. In various embodiments, the dense geographic characteristics comprise composite reward scores for geographic locations that are generated through a multi-level regression model pipeline that synthesizes prediction stratification data with entity feature vectors stored in association with a set of geographic locations represented by the interactive mapping interface. To overcome performance deficiencies with traditional rule-based and post stratification techniques, the multi-level regression model pipeline of the present disclosure synthesizes probability classifications for individuals within a limited dataset with class stratifications to scale reward scores across the set of geographic regions based on the individual features of the individuals within the set of geographic regions as well as the interactions between these features. In this way, the multi-level regression model pipeline of the present disclosure allows for feature-level scaling that addresses various technical deficiencies of tradition geographic scaling techniques. When applied within a digital mapping environment, the feature-level scaling techniques enable improved mapping interfaces that may be leveraged to automate various geographic-based actions.

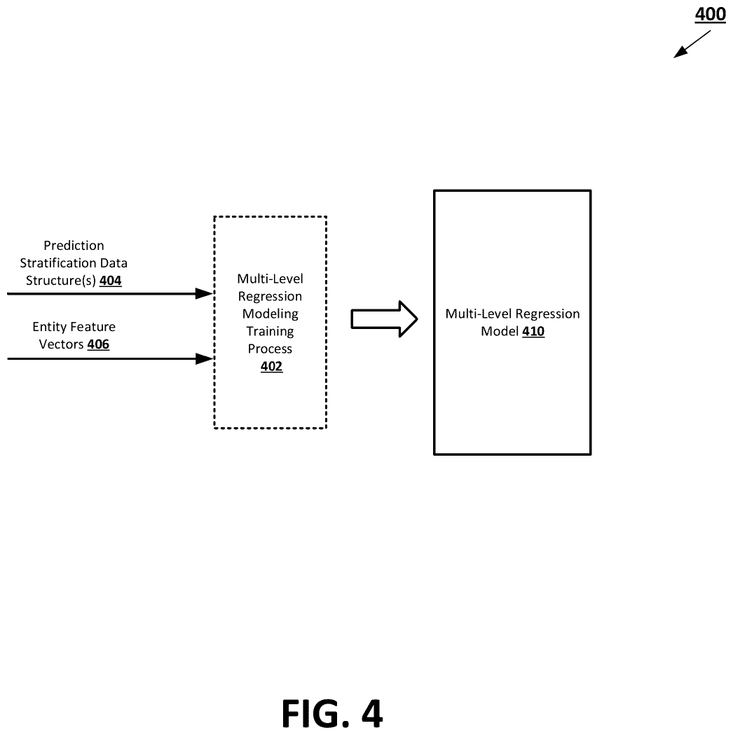

FIG. 4 depicts a dataflow diagram 400 showing example data structures, modules, and/or pipelines for implementing a multi-level regression model in accordance with some embodiments discussed herein. In some embodiments, the dataflow diagram 400 provides a configuration (e.g., training) stage for implementing a multi-level regression model that utilizes prediction stratification data structures and entity feature vectors for generating a training dataset for the multi-level regression model. The dataflow diagram 400 may provide an application of multi-level regression modeling and advanced data scaling techniques to enable more accurate predictions from limited sample data to optimize and compress geographic predictions across computing devices and/or geographic locations.

The dataflow diagram 400 comprises a multi-level regression modeling training process 402. In some embodiments, the computing system 100 performs the multi-level regression modeling training process 402. The computing system 100 may utilize one or more prediction stratification data structures 404 and a plurality of entity feature vectors 406 to perform the multi-level regression modeling training process 402. For example, the one or more prediction stratification data structures 404 and the plurality of entity feature vectors 406 may be utilized as input for the multi-level regression modeling training process 402.

In some embodiments, a prediction stratification data structure of the one or more prediction stratification data structures 404 is a data entity that groups and/or categorizes data for a requested class based on a data stratification technique. In some embodiments, a prediction stratification data structure of the one or more prediction stratification data structures 404 assigns a probability classification for a requested class to respective entity identifiers. The probability classification may be selected from a plurality of defined probability classifications for the requested class. The defined probability classifications may correspond to a prediction stratification (e.g., a prediction grouping or category) associated with the requested class.

In some embodiments, a prediction stratification data structure of the one or more prediction stratification data structures 404 comprises an indicator (e.g., a flag, a defined bit, etc.) that indicates whether an entity identifier is associated with a particular probability classification. In some embodiments, a prediction stratification data structure of the one or more prediction stratification data structures 404 additionally comprises an entity stratification table associated with data for respective entity identifiers. In some embodiments, a prediction stratification data structure of the one or more prediction stratification data structures 404 corresponds to at least a portion of a training dataset for a multi-level regression model 410.

In some embodiments, a prediction stratification data structure of the one or more prediction stratification data structures 404 may assign a probability classification of a plurality of defined probability classifications for a requested class to an entity identifier of a recorded entity cohort. In an example, a requested class may correspond to a particular disease domain such as multiple sclerosis, schizophrenia, or another type of disease. In addition, or alternatively, a prediction stratification data structure of the one or more prediction stratification data structures 404 may correspond to a disease stratification table that comprises one or more indicators to indicate whether a patient is qualified for a respective disease stratification.

In some embodiments, the entity identifier is a data entity that identifies an entity associated with data and/or a recorded entity cohort. In some embodiments, the entity identifier provides a link between various data points and/or attributes for an entity across different data structures. In a healthcare domain, the entity identifier may be a patient identifier that corresponds to a patient and/or patient information associated with one or more data elements and/or one or more data sources. In some embodiments, the entity identifier enables accurate synthesis of data from multiple sources and/or optimized application of model parameters to input data. In some embodiments, the entity identifier enables formatting and/or configuration of input data for one or more modeling tasks associated with the multi-level regression model 410.

In some embodiments, in a healthcare domain, the requested class is a particular disease and the prediction stratification data structure is a disease stratification table. In some embodiments, the disease stratification table comprises respective indicators that indicate whether a patient identifier is associated with a particular disease stratification. For example, the plurality of defined probability classifications may include a first probability classification corresponding to “active disease”, a second probability classification corresponding to “suspected disease”, and a third probability classification corresponding to “at-risk for disease”. Additionally, the disease stratification table may assign one of the first probability classification corresponding to “active disease”, the second probability classification corresponding to “suspected disease”, or the third probability classification corresponding to “at-risk for disease”to a patient identifier for a particular disease class.

In some embodiments, the prediction stratification data structure is generated based on a rules-based classification technique, one or more machine learning models (e.g., one or more classifier models), and/or another type of classification technique. In some embodiments, the prediction stratification data structure is utilized as input for a downstream modeling task provided by the multi-level regression model 410 for optimizing allocation of resources and/or initiating one or more prediction-based actions.

In some embodiments, an entity feature vector of the plurality of entity feature vectors 406 is vectorized input for the multi-level regression model 410. An entity feature vector of the plurality of entity feature vectors 406 may include a vectorized representation of entity information for an entity identifier that is extracted from a recorded entity cohort associated with the entity identifier. For example, an entity feature vector of the plurality of entity feature vectors 406 may include a vectorized representation of a plurality of features, attributes, and/or other data characteristics corresponding to a particular entity. In some embodiments, an entity feature vector of the plurality of entity feature vectors 406 is formatted and/or configured for a particular multi-level regression model 410.

In some embodiments, an entity feature vector of the plurality of entity feature vectors 406 encapsulates various characteristics of an entity in a format suitable for computational analysis and modeling. For example, in a healthcare domain, an entity feature vector for a patient may comprise demographic information (age, gender, location, etc.), medical history data, and/or patient profile data. In some embodiments, data of an entity feature vector of the plurality of entity feature vectors 406 may include predictive features for improving the performance of the particular multi-level regression model. In some embodiments, an entity feature vector of the plurality of entity feature vectors 406 may correspond to at least a portion of a training dataset for the multi-level regression model 410.

In some embodiments, the plurality of entity feature vectors 406 correspond to at least a portion of an independent variable dataset for the multi-level regression model 410. A training dataset may be a dataset that is used to train the multi-level regression model 410. In some embodiments, an entity feature vector of the plurality of entity feature vectors 406 is generated by utilizing feature extraction and/or selection of data from a recorded entity cohort associated with an entity identifier. In some embodiments, a feature extraction process comprises dimensionality reduction, feature scaling, and/or encoding of data stored in a recorded entity cohort.

Additionally, an entity feature vector of the plurality of entity feature vectors 406 may comprise an entity feature vector for the entity identifier of the recorded entity cohort. In some embodiments, the computing system 100 synthesizes the one or more prediction stratification data structures 404 and the plurality of entity feature vectors 406 via the multi-level regression modeling training process 402 to generate the multi-level regression model 410 for the requested class. The entity identifier may correspond to a patient that may be assigned to a disease or a disease sub-group. In addition or alternatively, the recorded entity cohort may correspond to a demographic-level table for the patient. The demographic information in the demographic-level table may comprise age, gender, location, and/or other demographic data.

In some embodiments, a probability classification is a data construct that describes a classification, prediction, and/or inference associated with a probability that an entity identifier corresponds to a sub-group of a requested class. A probability classification may be selected from a plurality of defined probability classifications for the requested class. The plurality of defined probability classifications may be respective sub-groups for the requested class. In some embodiments, a probability classification is associated with a scaling coefficient indicative of a likelihood that an entity identifier satisfies defined criteria for the requested class. For example, in a healthcare domain, a scaling coefficient may be indicative of a likelihood that a patient is eligible for a particular type of medication associated with a disease class.

In some embodiments, the requested class is a data construct associated with a particular category, condition, or characteristic of interest for a modeling task. For example, in a healthcare domain, a requested class may be a may be a particular disease such as, but not limited to, diabetes or schizophrenia. In a manufacturing context, a requested class may be a category of asset behavior or risk.

In some embodiments, the recorded entity cohort is a data entity that describes a particular entity. The recorded entity cohort may include a plurality of features, attributes, and/or other data characteristics corresponding to a particular entity. In some examples, the recorded entity cohort may include an entity profile identifying a plurality of features, attributes, and/or other data characteristics corresponding to corresponding to a healthcare domain. In some examples, the plurality of features, attributes, and/or other data characteristics may be distributed across a plurality of different information channels. Each of the plurality of features, attributes, and/or other data characteristics may include one or more searchable attributes, such as source text attributes that may be searched using keyword matching techniques, source embedding attributes that may be searched using embedding matching techniques, and/or the like. In some embodiments, a recorded entity cohort includes demographic information, historical records, data related to a requested class, and/or other data.

In some embodiments, the plurality of defined probability classifications comprise a first probability classification associated with a first scaling coefficient, a second probability classification associated with a second scaling coefficient, and a third probability classification associated with a third scaling coefficient. In addition or alternatively, a reward score for each probability classification may be based on the first scaling coefficient, the second scaling coefficient, and the third scaling coefficient. In some embodiments, the plurality of defined probability classifications comprise a different number of probability classifications (e.g., more than three probability classifications, less than three probability classifications, etc.). In some examples, the first probability classification may correspond to an active disease classification, the second probability classification may correspond to a suspected disease classification, and the third probability classification may correspond to an at-risk disease classification.

In some embodiments, a probability classification for a prediction stratification data structure of the one or more prediction stratification data structures 404 is the first probability classification in response to a historical indication of the requested class within a historical feature set associated with the entity identifier. In other embodiments, a probability classification for a prediction stratification data structure of the one or more prediction stratification data structures 404 is the second probability classification in response to a rule-based positive output, from a rule-based model corresponding to the requested class, based on the historical feature set associated with the entity identifier. In other embodiments, a probability classification for a prediction stratification data structure of the one or more prediction stratification data structures 404 is the third probability classification in response to a machine-learned positive output, from a machine learned model corresponding to the requested class, based on the historical feature set associated with the entity identifier.

In some embodiments, a prediction stratification data structure of the one or more prediction stratification data structures 404 comprises an entity stratification table. The entity stratification table may comprise a training entry for the entity identifier. For example, the training entry may comprise a probability classification flag or another type of probability classification indicator for each of the plurality of defined probability classifications. In some embodiments, the computing system 100 augments the training entry with the entity feature vector. Additionally, the computing system 100 may train the multi-level regression model 410 based on a correlation between an entity feature vector of the plurality of entity feature vectors 406 and the probability classification flag for each of the plurality of defined probability classifications. In some embodiments, the entity feature vector may comprise a plurality of independent training parameters. Additionally, in some embodiments, the probability classification flag for each of the plurality of defined probability classifications may comprise a plurality of dependent training parameters for the multi-level regression model 410.

The multi-level regression model 410 may be a hardware and/or software architecture having one or more parameters and/or coefficients that defined the architecture of the multi-level regression model 410. In some embodiments, the one or more parameters and/or coefficients of the multi-level regression model 410 are determined and/or tuned during training the multi-level regression model 410. In some examples, structural parameter(s) may define component(s) of the model's architecture and/or their configuration/order, such as, for example, the configuration/order specifying which output(s) of one component are provided as input to other component(s); a number, type, and/or configuration of component(s) per layer, a number of layers of the model, a type of estimation technique for the model, and/or the like. In some embodiments, the multi-level regression model 410 is configured to utilize one or more modeling techniques, such as hierarchical linear modeling, mixed-effects modeling, etc.

In some embodiments, the multi-level regression model 410 is trained using one or more training techniques related to maximum likelihood estimation, Bayesian inferences, etc. In some embodiments, the multi-level regression model 410 is trained based on one or more prediction stratification data structures and a plurality of entity feature vectors. Once trained, the multi-level regression model 410 may be applied to a target cohort (e.g., a target cohort within a requested geographic location) to generate a composite reward score for the requested geographic location. In some embodiments, demographic features correspond to independent variables and reward scores correspond to dependent variables for the multi-level regression model 410.

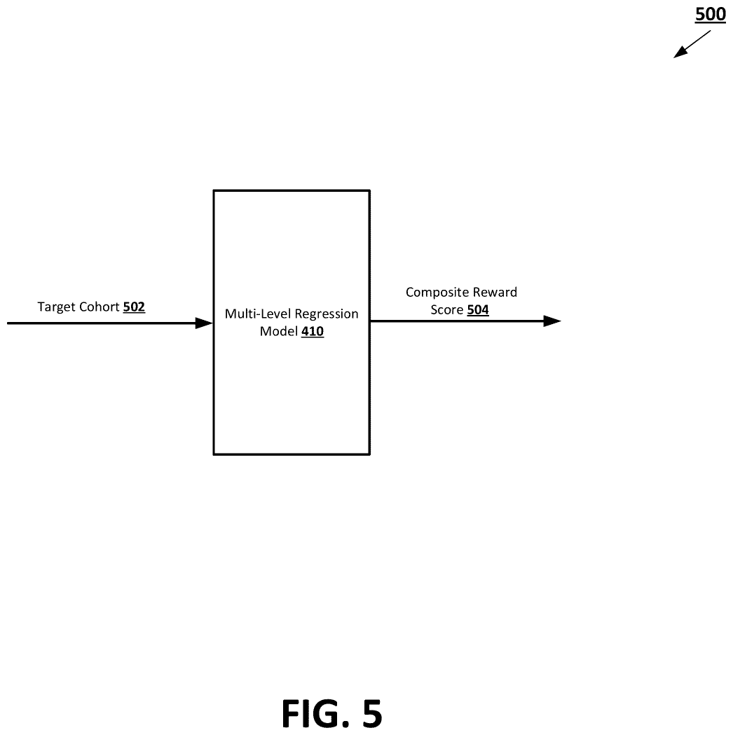

FIG. 5 depicts a dataflow diagram 500 showing example data structures, modules, and/or pipelines for utilizing a trained multi-level regression model in accordance with some embodiments discussed herein. In some embodiments, the dataflow diagram 500 provides a modeling stage for a multi-level regression model that utilizes a target cohort to generate a composite reward score associated with the one or prediction stratification data structures 404 and the plurality of entity feature vectors 406. The dataflow diagram 500 may provide an application of multi-level regression modeling and advanced data scaling techniques to enable more accurate predictions from limited sample data to optimize resource allocation across computing devices and/or geographic locations.

The dataflow diagram 500 comprises the multi-level regression model 410. In some embodiments, the computing system 100 applies the multi-level regression model 410 to a target cohort 502 within a requested geographic location to generate a composite reward score 504 for the requested geographic location. In some embodiments, the composite reward score 504 combines a reward score for each probability classification of the plurality of defined probability classifications for the requested class.

The target cohort 502 may be a data entity that describes a group of entity identifiers associated with a requested geographic location. The target cohort 502 may represent a subset of entity identifiers at a requested geographic location. Additionally, the target cohort 502 may be associated with plurality of features, attributes, and/or other data characteristics corresponding to the group of entity identifiers. For example, in a healthcare domain, the target cohort 502 may be entity identifiers within a certain age range or with specific risk factors for a particular disease. In some embodiments, the target cohort 502 may correspond to a group to which the multi-level regression model 410 is applied to generate a composite reward score. In some embodiments, the multi-level regression model 410 may be utilized to predict probability classifications for entity identifiers within the target cohort 502 based on respective characteristics and/or features associated with a requested geographic location.

In some embodiments, the term requested geographic location is a data entity that describes a specific geographic location or geographic area for a modeling task associated with resource allocation. The requested geographic location may correspond to a city, state, country, region within a city, a hospital location, a floor or area of a hospital, a manufacturing site, or another type of physical location.

The composite reward score 504 may be a data entity that describes an aggregate measure that combines respective reward scores for each defined probability classification within a requested class for a requested geographic location. The composite reward score 504 may include a real number, percentage, ratio, and/or any other likelihood representation.

A reward score may be a data entity that describes a binary and/or probabilistic measure of a likelihood that a defined probability classification will satisfy prediction criteria for a requested class. In some embodiments, a reward score is a probability that an entity identifier will satisfy criteria for a sub-group of a requested class. A reward score may include a real number, percentage, ratio, and/or any other likelihood representation. In some embodiments, a first defined probability classification is associated with a first reward score, a second defined probability classification is associated with a second reward score, a third defined probability classification is associated with a third reward score, etc. In a healthcare domain where a requested class is a particular disease, different reward scores may be assigned to a defined probability classification such as “active disease” (e.g., reward score of 1.0), “suspected disease” (e.g., reward score of 0.7), and “at-risk for disease” (e.g., reward score of 0.5).

In some embodiments, the computing system 100 receives from the multi-level regression model 410, a first stratification prediction for the first probability classification, a second stratification prediction for the second probability classification, and a third stratification prediction for the third probability classification. Additionally, the computing system 100 may apply the first scaling coefficient to the first stratification prediction to generate a first reward score for the first probability classification, apply the second scaling coefficient to the second stratification prediction to generate a second reward score for the second probability classification, and apply the third scaling coefficient to the third stratification prediction to generate a third reward score for the third probability classification. The computing system 100 may also aggregate the first reward score, the second reward score, and the third reward score to generate the composite reward score 504 for the requested geographic location.

In some embodiments, the computing system 100 utilizes the multi-level regression model 410 to generate the composite reward score responsive to a routing request from a user that identifies the requested class and the requested geographic location. In some embodiments, the computing system 100 utilizes the multi-level regression model 410 to generate the composite reward score responsive to a manufacturing request from a user that identifies the requested class and the requested geographic location.

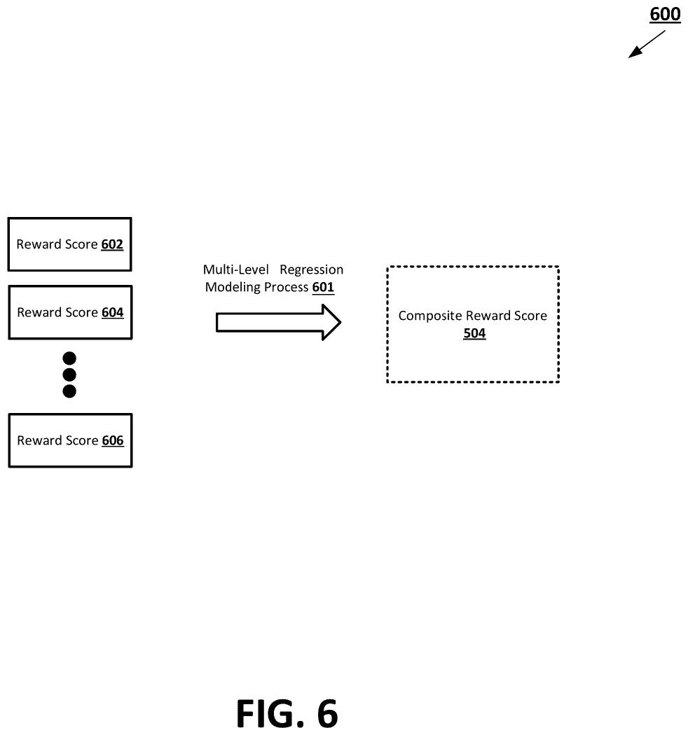

FIG. 6 depicts a dataflow diagram 600 showing example data structures, modules, and/or pipelines for performing a multi-level regression modeling process in accordance with some embodiments discussed herein. The dataflow diagram 600 may provide an application of multi-level regression modeling and advanced data scaling techniques to enable more accurate predictions from limited sample data to optimize resource allocation across computing devices and/or geographic locations.

The dataflow diagram 600 comprises a multi-level regression modeling process 601. In some embodiments, the computing system 100 performs the multi-level regression modeling process 601. In some embodiments, the computing system 100 performs the multi-level regression modeling process 601 to combine a reward score for each probability classification of the plurality of defined probability classifications into the composite reward score. For example, the computing system 100 may apply the first scaling coefficient to the first stratification prediction to generate a first reward score 602 for the first probability classification. Additionally, the computing system 100 may apply the second scaling coefficient to the second stratification prediction to generate a second reward score 604 for the second probability classification. The computing system 100 may also apply the third scaling coefficient to the third stratification prediction to generate a third reward score 606 for the third probability classification. To generate the composite reward score 504, the computing system 100 may aggregate the first reward score 602, the second reward score 604, and the third reward score 606.

In some embodiments, the computing system 100 initiates the performance of a prediction-based action for the requested geographic location based on the composite reward score 504. For example, the prediction-based action may comprise real-time configuration of a user interface based on the composite reward score 504 to enable a user to consume visual data associated with the geographic location in an interactive manner, where the visual data is tailored based on the composite reward score 504. In another example, the prediction-based action may comprise an automated drug manufacturing, routing, and/or storage action. For instance, responsive to composite reward score 504, the computing system 100 may provide one or more instructions to a resource manufacturing device (e.g., a pharmaceutical manufacturing device, etc.) to cause a development of one or more resources (e.g., one or more pharmaceutical resources, one or more hospital resources, one or more medications, etc.). In some examples, the one or more instructions may be tailored to the geographic location. In yet another example, the prediction-based action may comprise providing input to an optimization model based on the composite reward score 504 to identify, for example, one or more geographic locations for allocating resources (e.g., allocating pharmaceutical resources, hospital resources, medications, etc.). In some embodiments, the optimization model is a machine-learned model that is executed based on output of the multi-level regression model 410. In some embodiments, the computing system 100 initiates the performance of the prediction-based action for the requested geographic location responsive to the composite reward score meeting or exceeding a threshold.

In some embodiments, the computing system 100 generates the composite reward score 504 responsive to a routing request from a user that identifies the requested class and the requested geographic location. Additionally, the computing system 100 may initiate the performance of the prediction-based action for the requested geographic location responsive to the composite reward score 504 meeting or exceeding a routing threshold.

In some embodiments, the computing system 100 generates the composite reward score 504 responsive to a manufacturing request from a user that identifies the requested class and the requested geographic location, Additionally, the computing system 100 may initiate the performance of the prediction-based action for the requested geographic location responsive to the composite reward score 504 meeting or exceeding a resource limit. In some embodiments, the computing system 100 transmits a control instruction to a resource manufacturing device to control a manufacturing level of a resource corresponding to the requested class.

In some embodiments, the requested geographic location is one of a plurality of requested geographic locations. In some embodiments, the computing system 100 receives, via a user interface, a mapping request for a user associated with an input geographic location. Additionally, the computing system 100 may receive a plurality of composite reward scores that comprise the composite reward score 504 and an additional composite reward score for an additional geographic location within a search radius of the input geographic location. In some embodiments, the computing system 100 inputs the plurality composite reward scores, the input geographic location, the requested geographic location, and the additional geographic location to an optimization model to generate a user route. In some embodiments, the user interface comprises a mapping interface that reflects a geographic region. The geographic region may comprise the input geographic location, the requested geographic location, and the additional geographic location. In some embodiments, responsive to the mapping request, the computing system 100 may initiate the presentation of a routing overlay to the geographic region that identifies the user route. In some embodiments, the routing overlay may further identify the composite reward score 504 for the requested geographic location and the additional composite reward score for the additional geographic location.

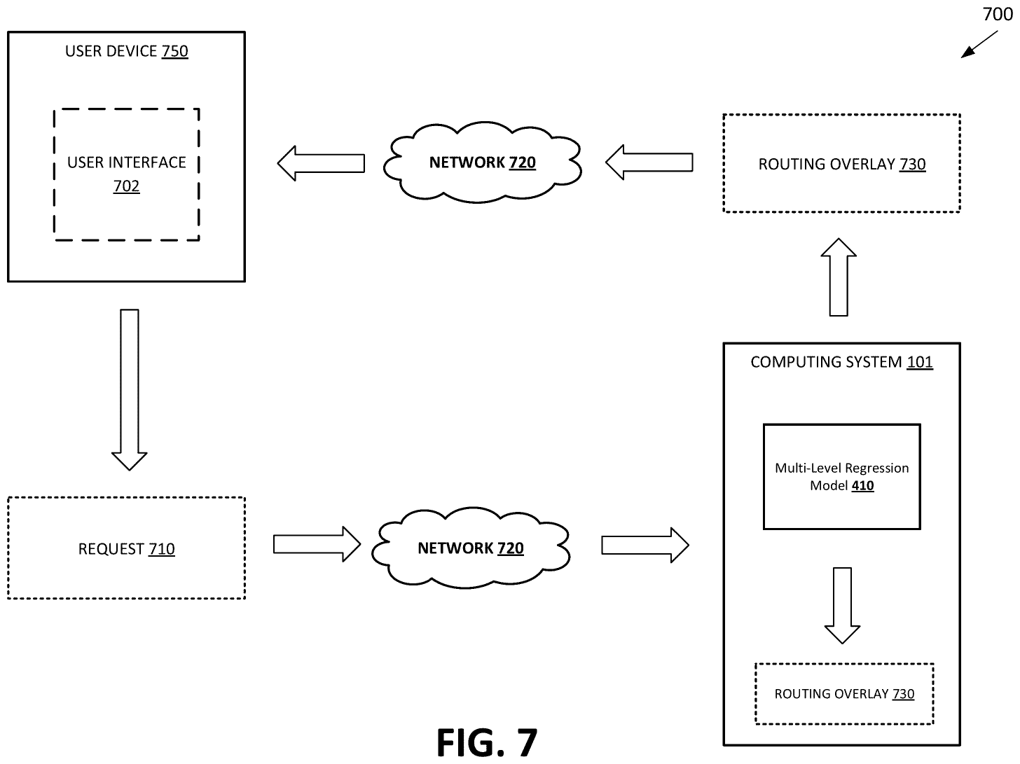

FIG. 7 depicts an interactive map-based visualization system 700 showing example devices, systems, engines, data structures, and/or processes for generating a routing overlay for rendering via a user interface in accordance with some embodiments discussed herein. In some embodiments, the map-based visualization system 700 may enable real-time configuration of a user interface based on the composite reward score 504. The map-based visualization system 700 may further enable a user to consume visual data associated with the geographic location in an interactive manner, where the visual data is tailored based on the composite reward score 504.

In some embodiments, the interactive map-based visualization system 700 comprises a user interface 702 of a user device 750. The user interface 702 may be an electronic interface for a web page, a mobile application, an electronic portal, a chatbox (e.g., an LLM-based chatbox), and/or the like. Additionally, a request 710 associated with the user interface 702 may be generated by the user device 750. For example, the request 710 may be a user interface request. In some embodiments, the request 710 may be a mapping request for a user associated with an input geographic location. In some embodiments, the user device 750 may transmit the request 710 to the computing system 101 via a network 720. The network 720 may be configured based on one or more wired and/or wireless communication protocols. For example, the network 720 may provide communication executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, as further disclosed herein.

In some embodiments, the request 710 comprises character-level text input associated with a structured and/or natural language sequence of text (e.g., one or more alphanumeric characters, symbols, etc.). In some examples, the character-level text input may comprise user input, such as text input and/or text generated from one or more audio, tactile, and/or like inputs related to the user interface 702. In some examples, the character-level text input may comprise a natural language sequence of text provided via the user interface 702. In some examples, character-level text input may comprise a natural language sequence of text that expresses a question, preference, and/or the like. In addition or alternatively, the character-level text input may comprise one or more contextual query attributes for constraining a result for the natural language sequence of text.

In some embodiments, the request 710 may comprise or otherwise be associated with one or more request attributes such as a location attribute (e.g., a GPS position, a latitude/longitude, etc.) and/or the like. For example, the one or more request attributes may comprise user location data. The user location data may comprise a real-time location approximation associated with the user device 750, data (e.g., a GPS position, a latitude/longitude, etc.) provided by a location module of the user device 750, data associated with a network connection (e.g., a 5G connection, an internet protocol (IP) address, etc.) associated with the user device 750, data based on location text input provided by a user via the user interface 702, a geofence location associated with the user device 750, and/or other location data associated with the user device 750.

In some embodiments, the user location data includes location information (e.g., a GPS position, a latitude/longitude, an address, a geofence location, etc.) associated with a user device and/or a user identifier. In some embodiments, the user location data is based on a location module of the user device. The location module may be adapted to acquire, for example, latitude, longitude, altitude, geocode, course, direction, heading, speed, UTC, date, and/or various other information/data. In one embodiment, the location module may acquire data, such as ephemeris data, by identifying the number of satellites in view and the relative positions of those satellites (e.g., using GPS). The satellites may be a variety of different satellites, including LEO satellite systems, DOD satellite systems, the European Union Galileo positioning systems, the Chinese Compass navigation systems, Indian Regional Navigational satellite systems, and/or the like. This data may be collected using a variety of coordinate systems, such as the DD; DMS; UTM; UPS coordinate systems; and/or the like. Alternatively, the location information/data may be determined by triangulating a position of the user device in connection with a variety of other systems, including cellular towers, Wi-Fi access points, and/or the like. In some embodiments, the location module may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, BLE transmitters, NFC transmitters, and/or the like.

In some embodiments, the computing system 101 receives the request 710 via the network 720. In some embodiments, the computing system 101 utilizes the multi-level regression model 410 to generate a routing overlay 730. In some embodiments, responsive to the request 710, the computing system 100 may initiate presentation of the routing overlay 730 via the user interface 702. For example, the computing system 100 may initiate presentation of the routing overlay 730 to the geographic region that identifies the user route. In some embodiments, the routing overlay may further identify the composite reward score 504 for the requested geographic location and/or one or more additional composite reward scores for one or more additional geographic locations.

In some embodiments, the routing overlay 730 may formatted to provide a visualization and/or human interpretation of data via the user interface 702. In some embodiments, the routing overlay 730 and/or one or more computer-executable instructions associated therewith may be formatted for transmission via the network 720. For example, the routing overlay 730 may be formatted for transmission via an API, a communication channel, a communication interface, or combinations thereof. In one or more embodiments, the routing overlay 730 may comprise one or more user interface elements that may be interacted with via the user interface 702.

In some embodiments, the computing system 101 transmits the routing overlay 730 to the user device 750 via the network 720. In some embodiments, the computing system 101 initiates a rendering of the routing overlay 730 via the user interface 702 of the user device 750. In some embodiments, the routing overlay 730 may be correlated to a real-time map visualization displayed via the user interface 702. In various embodiments, the computing system 101 utilizes the multi-level regression model 410 such that the routing overlay 730 is rendered via the user interface 702 in real-time or approximately in real-time (e.g., within 40 milliseconds or approximately 40 milliseconds, etc.) with respect to generation of the request 710 by the user device 750. As such, an efficient and cost-effective user interface visualization may be provided for the user device 750 by utilizing the computing system 101.

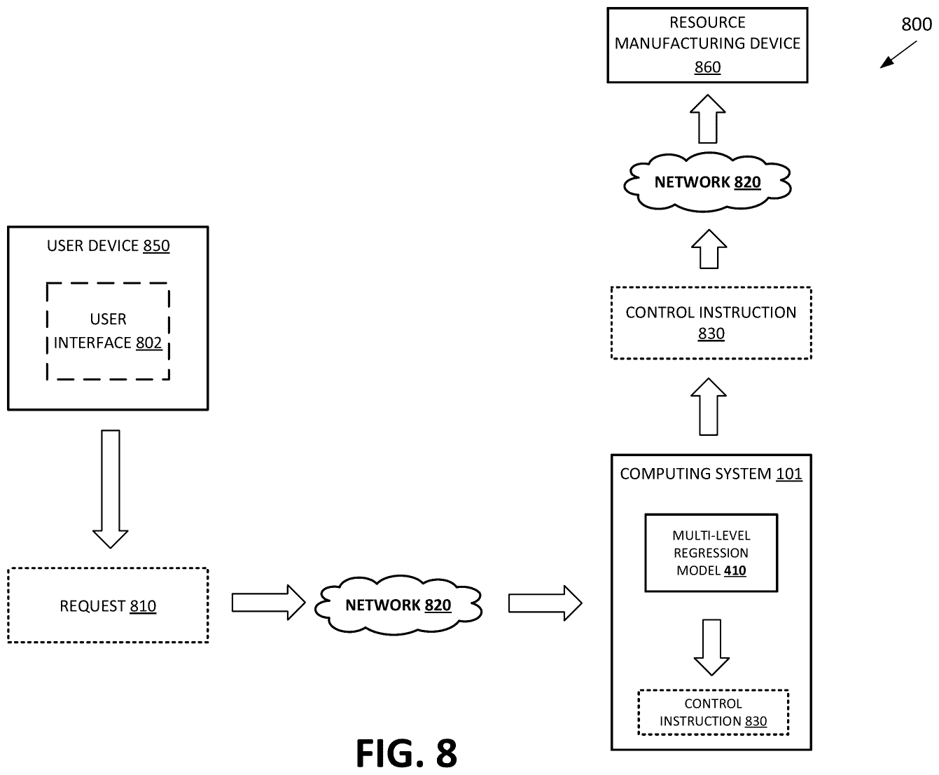

FIG. 8 depicts a resource manufacturing device management system 800 showing example devices, systems, engines, data structures, and/or processes for generating a routing overlay for rendering via a user interface in accordance with some embodiments discussed herein. In some embodiments, the resource manufacturing device management system 800 may enable optimization of resource allocation associated with a resource manufacturing device based on the composite reward score 504. The resource manufacturing device management system 800 may further enable optimized performance of a resource manufacturing device based on the composite reward score 504.

In some embodiments, the resource manufacturing device management system 800 comprises a user interface 802 of a user device 850. The user interface 802 may be an electronic interface for a web page, a mobile application, an electronic portal, a chatbox (e.g., an LLM-based chatbox), and/or the like. Additionally, a request 810 associated with the user interface 802 may be generated by the user device 850. For example, the request 810 may be a user interface request. In some embodiments, the request 810 may be a manufacturing request from a user that identifies a requested class and a requested geographic location. In some embodiments, the user device 850 may transmit the request 810 to the computing system 101 via a network 820. The network 820 may be configured based on one or more wired and/or wireless communication protocols. For example, the network 820 may provide communication executed using a wired data transmission protocol, such as FDDI, DSL, Ethernet, ATM, frame relay, DOCSIS, or any other wired transmission protocol. In addition, or alternatively, the predictive computing entity 102 may be configured to communicate via wireless external communication using any of a variety of protocols, as further disclosed herein.

In some embodiments, the request 810 comprises character-level text input associated with a structured and/or natural language sequence of text (e.g., one or more alphanumeric characters, symbols, etc.). In some examples, the character-level text input may comprise user input, such as text input and/or text generated from one or more audio, tactile, and/or like inputs related to the user interface 802. In some examples, the character-level text input may comprise a natural language sequence of text provided via the user interface 802. In some examples, character-level text input may comprise a natural language sequence of text that expresses a question, preference, and/or the like. In addition or alternatively, the character-level text input may comprise one or more contextual query attributes for constraining a result for the natural language sequence of text.

In some embodiments, the request 810 may comprise or otherwise be associated with one or more request attributes such as a location attribute (e.g., a GPS position, a latitude/longitude, etc.) and/or the like. For example, the one or more request attributes may comprise user location data. The user location data may comprise a real-time location approximation associated with the user device 850, data (e.g., a GPS position, a latitude/longitude, etc.) provided by a location module of the user device 850, data associated with a network connection (e.g., a 5G connection, an internet protocol (IP) address, etc.) associated with the user device 850, data based on location text input provided by a user via the user interface 802, a geofence location associated with the user device 850, and/or other location data associated with the user device 850.

In some embodiments, the computing system 101 receives the request 810 via the network 820. In some embodiments, the computing system 101 utilizes the multi-level regression model 410 to generate a control instruction 830. In some embodiments, responsive to the request 810, the computing system 100 may initiate transmission of the control instruction 830 to a resource manufacturing device 860 via the network 820. For example, the computing system 100 may utilize the composite reward score 504 to transmit the control instruction 830 to the resource manufacturing device 860. In some embodiments, the computing system 100 transmits the control instruction 830 to the resource manufacturing device 860 responsive the composite reward score 504 meeting or exceeding a resource limit. In some embodiments, the computing system 100 transmits the control instruction 830 to the resource manufacturing device 860 to control a manufacturing level of a resource corresponding to a requested class associated with the request 810.

In some embodiments, the control instruction 830 may be formatted for transmission via the network 820. For example, the control instruction 830 may be formatted for transmission via a communication channel, a communication interface, or combinations thereof. In various embodiments, the computing system 101 utilizes the multi-level regression model 410 such that the control instruction 830 is transmitted to the resource manufacturing device 860 in real-time or approximately in real-time (e.g., within 40 milliseconds or approximately 40 milliseconds, etc.) with respect to generation of the request 810 by the user device 850. As such, an efficient and cost-effective configuration of the resource manufacturing device 860 may be provided for the user device 850 by utilizing the computing system 101.

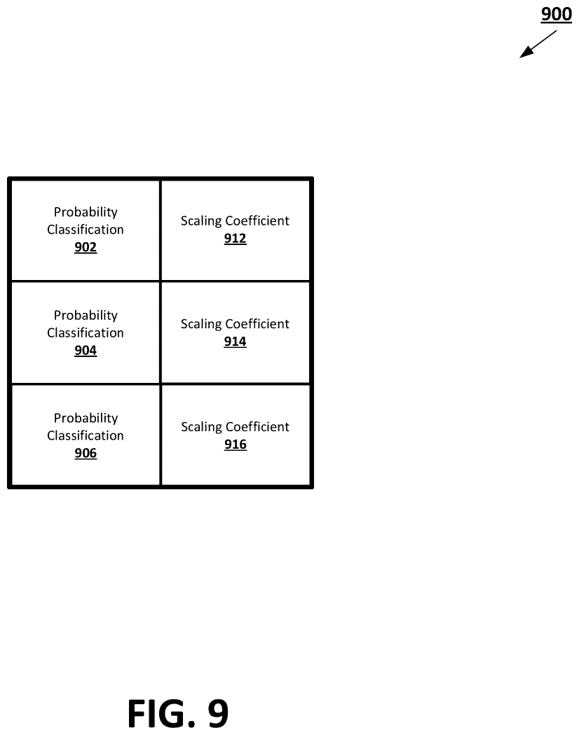

FIG. 9 depicts an example plurality of defined probability classifications 900 for a requested class in accordance with some embodiments discussed herein. For example, the plurality of defined probability classifications 900 may be a stratification group for a particular disease (e.g., multiple sclerosis, schizophrenia, etc.). In some embodiments, the plurality of defined probability classifications 900 comprises a first probability classification 902 associated with a first scaling coefficient 912, a second probability classification 904 associated with a second scaling coefficient 914, and a third probability classification 906 associated with a third scaling coefficient 916. In some embodiments, the computing system 101 determines a reward score for a probability classification based on the first scaling coefficient 912, the second scaling coefficient 914, and/or the third scaling coefficient 916. For example, the computing system 100 may receive, from the multi-level regression model 410, a first stratification prediction for the first probability classification 902, a second stratification prediction for the second probability classification 904, and a third stratification prediction for the third probability classification 906. Additionally, the computing system 100 may apply the first scaling coefficient 912 to the first stratification prediction to generate a first reward score for the first probability classification 902, apply the second scaling coefficient 914 to the second stratification prediction to generate a second reward score for the second probability classification 904, and apply the third scaling coefficient 916 to the third stratification prediction to generate a third reward score for the third probability classification 906. The computing system 100 may also aggregate the first reward score, the second reward score, and the third reward score to generate the composite reward score 504 for the requested geographic location.

In an example, the first probability classification 902 may correspond to an active disease classification (e.g., medicated with oral antipsychotic) for a schizophrenia disease, the second probability classification 904 may correspond to a suspected disease classification (e.g., medicated with any antipsychotic) for a schizophrenia disease, and the third probability classification 906 may correspond to an at-risk disease classification (e.g., not medicated) for a schizophrenia disease. Additionally, the scaling coefficient 912 may be a relative market value equal to “1.0” associated with a first likelihood that a patient in a group would be eligible for mediation, the scaling coefficient 914 may be a relative market value equal to “0.7” associated with a second likelihood that a patient in a group would be eligible for mediation, and the scaling coefficient 916 may be a relative market value equal to “0.5” associated with a third likelihood that a patient in a group would be eligible for mediation.

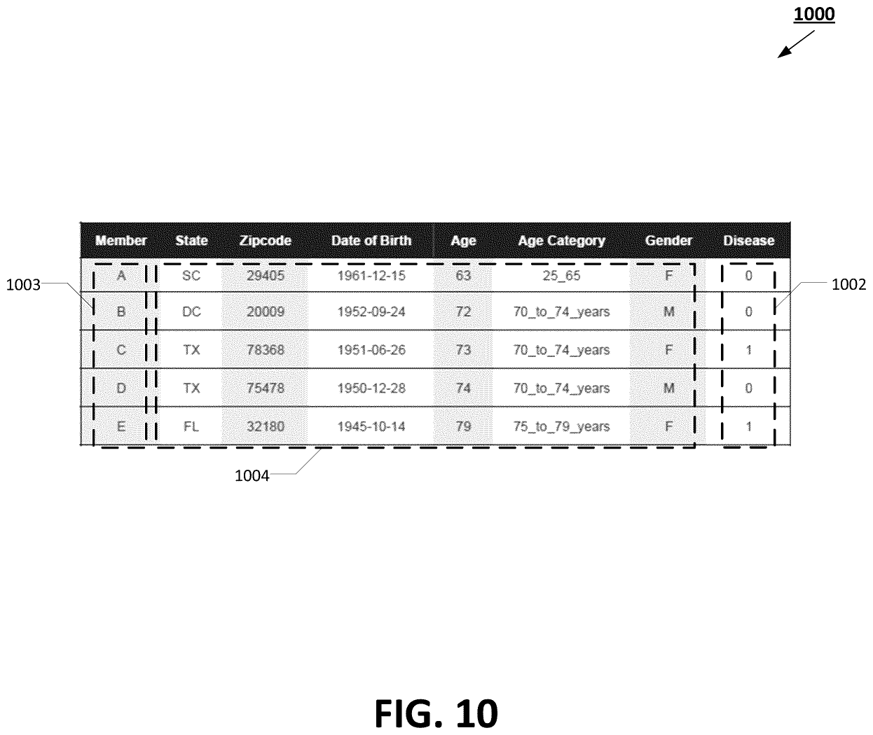

FIG. 10 depicts an example entity stratification table 1000 in accordance with some embodiments discussed herein. For example, the entity stratification table 1000 may comprise a training entry 1002 for a respective entity identifier 1003 that comprises a probability classification flag for each of the plurality of defined probability classifications 900. The entity stratification table 1000 may additionally comprise a respective entity feature vector 1004 for a respective entity identifier 1003. In some embodiments, the respective entity feature vector 1004 may comprise demographic information in the demographic-level table may comprise age, gender, location, and/or other demographic data.

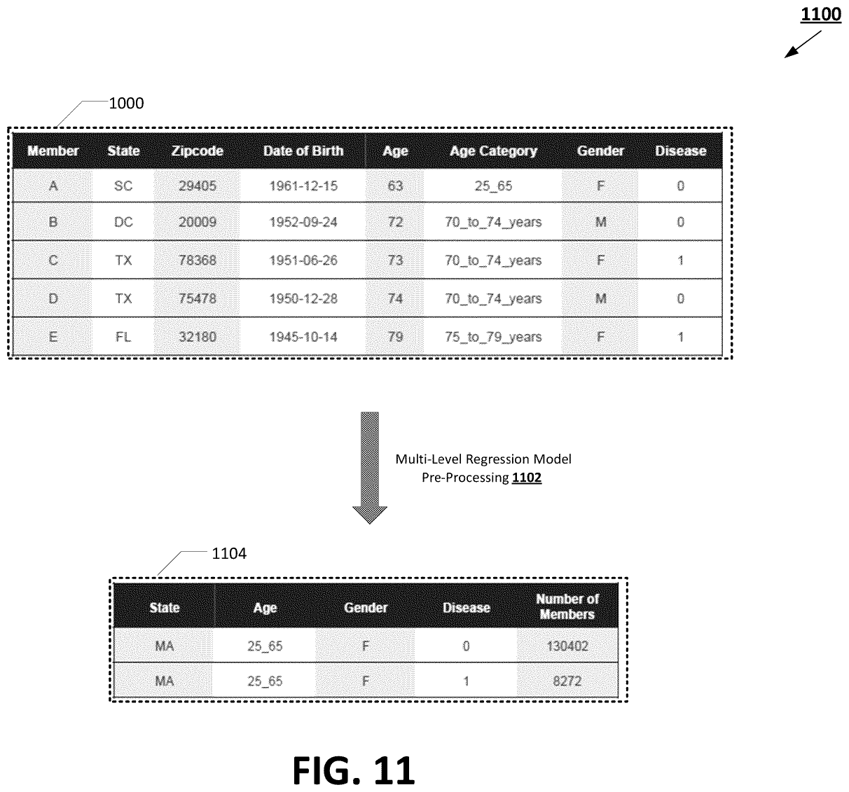

FIG. 11 depicts a dataflow diagram 1100 showing example data structures, modules, and/or pipelines for training a multi-level regression model in accordance with some embodiments discussed herein. In some embodiments, the dataflow diagram 1100 provides a pre-processing stage for a multi-level regression model that utilizes data scaling to generate a prediction stratification data structure. The dataflow diagram 1100 may provide improved input for multi-level regression modeling to enable more accurate predictions from limited sample data to optimize resource allocation across computing devices and/or geographic locations.

The dataflow diagram 1100 comprises multi-level regression modeling pre-processing 1102. In some embodiments, the computing system 100 performs the multi-level regression modeling pre-processing 1102. In some embodiments, the computing system 100 performs the multi-level regression modeling pre-processing 1102 to transform the entity stratification table 1000 into a prediction stratification data structure 1104. For example, the prediction stratification data structure 1104 may be an example prediction stratification data structure of the one or more prediction stratification data structures 404. The prediction stratification data structure 1104 may assign a probability classification of a plurality of defined probability classifications for a requested class to an entity identifier of a recorded entity cohort. For example, the prediction stratification data structure 1104 may be a disease stratification table connected to demographic information available for patients. The demographic information may comprise age, gender, location, and/or other demographic data obtained from the entity stratification table 1000. In some examples, the prediction stratification data structure 1104 may be configured at a stratification-unique demographic grouping level. In some embodiments, the computing system 100 synthesizes the prediction stratification data structure 1104 with a plurality of entity feature vectors (e.g., the plurality of entity feature vectors 406) to generate the multi-level regression model 410.

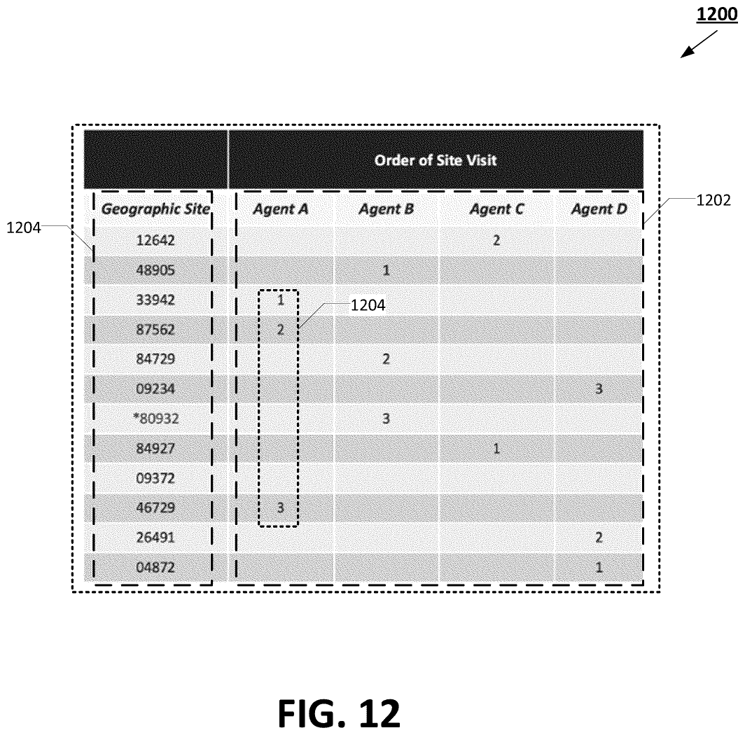

FIG. 12 depicts an example prediction output 1200 provided by the multi-level regression model 410 in accordance with some embodiments discussed herein. In some embodiments, the prediction output 1200 is a data construct that describes one or more prediction recommendations, insights, classifications, inferences, and/or other output provided by the multi-level regression model 410. In some embodiments, prediction recommendations, insights, classifications, and/or inferences may be with respect to a routing overlay and/or a resource manufacturing device. For example, the prediction output 1200 may indicate optimized allocation of resources 1202 per geographic location 1204. In some examples, the prediction output 1200 may comprise routing information 1206 that indicates a route between two or more geographic locations 1204 for a particular resource 1202. For example, the routing information 1206 may indicate which geographic locations 1204 should be correlated to a particular resource 1202 (e.g., which geographic locations 1204 should be visited by an agent) and the route between the indicated geographic locations for the particular resource 1202 (e.g., the route the agent should take between the indicated geographic locations).

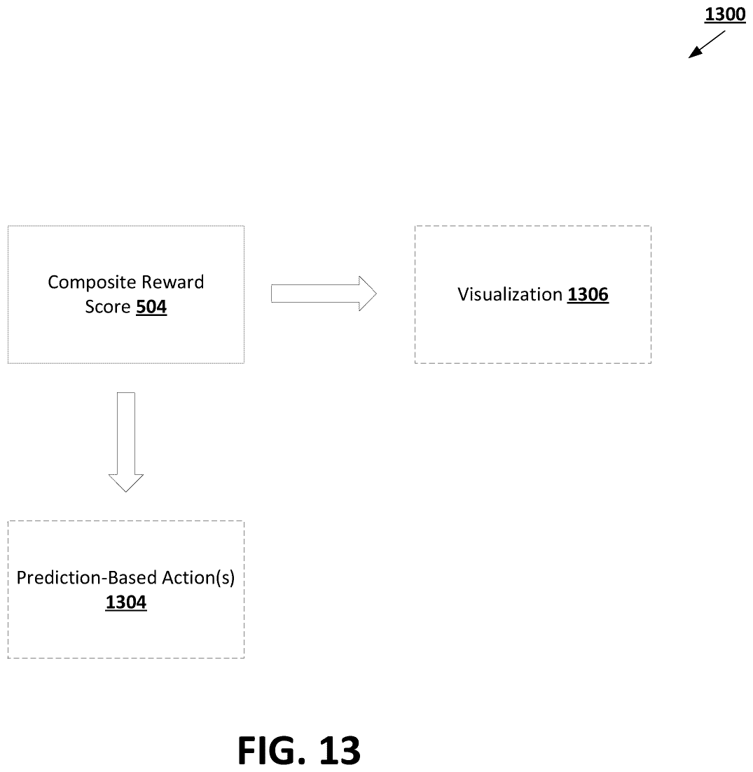

FIG. 13 depicts an example system 1300 for providing prediction-based actions and/or visualizations, in accordance with one or more embodiments of the present disclosure. The system 1300 comprises the composite reward score 504 provided by multi-level regression model 410. In one or more embodiments, one or more prediction-based actions 1304 are performed based on the composite reward score 504. For example, the performance of the one or more prediction-based actions 1304 may be initiated based on the composite reward score 504. In some embodiments, the performance of the one or more prediction-based actions 1304 may be initiated via an optimization model. For example, in some embodiments, the performance of the one or more prediction-based actions 1304 may be initiated via a predictive machine learned model that is trained for a different predictive task than the multi-level regression model 410. In some embodiments, data associated with the composite reward score 504 may be stored in a storage system, such as the volatile memory 215, the non-volatile memory 210, the volatile memory 322, or the non-volatile memory 324. The data stored in the storage system may be employed for providing user interface renderings, graphical visualizations, machine learning, recommendations, reporting, decision-making purposes, operations management, healthcare management, configuring a resource manufacturing device, and/or other purposes. In certain embodiments, the data stored in the storage system may be employed to provide one or more insights to assist with healthcare decision making processes, such as, medical decisions for a patient. In addition or alternatively, one or more machine learned models may be retrained based on one or more features associated with the composite reward score 504. For example, one or more relationships between features mapped in a machine learned model may be adjusted (e.g., refitted, tuned, etc.) based on data associated with the composite reward score 504. In another example, cross-validation, hyperparameter optimization, and/or regularization associated with a machine learned model may be adjusted based on one or more features associated with the composite reward score 504. In addition or alternatively, a visualization 1306 may be generated based on the composite reward score 504. The visualization 1306 may comprise, for example, one or more interactive graphical elements for a user interface (e.g., the user interface 702 or the user interface 802) based on the composite reward score 504.

In some embodiments, the one or more prediction-based actions 1304 may comprise automated user interface actions, automated alerts, automated instructions to user devices, and/or automated adjustments to allocations of computing resources. Further, the one or more prediction-based actions 1304 may comprise automated physician notification actions, automated patient notification actions, automated appointment scheduling actions, automated prescription recommendation actions, automated record updating actions, automated datastore updating actions, automated workforce management operational management actions, automated server load balancing actions, automated resource allocation actions, automated pricing actions, automated plan update actions, automated alert generation actions, generating one or more electronic communications, and/or the like. The one or more prediction-based actions 1304 may further comprise displaying visual renderings of the aforementioned examples of prediction-based actions in addition to values, charts, and representations associated with the one or more policy scores and the prediction output using a prediction output user interface such as the visualization 1306.

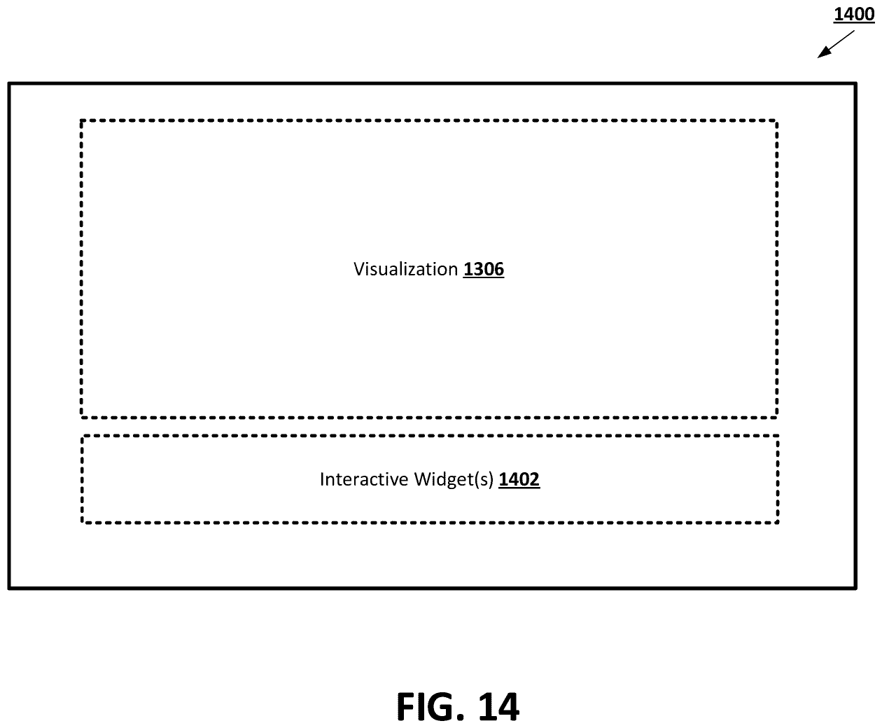

FIG. 14 depicts an example user interface 1400, in accordance with one or more embodiments of the present disclosure. In one or more embodiments, the user interface 1400 is, for example, an electronic interface (e.g., a graphical user interface) of the client computing entity 102. In some embodiments, the user interface 1400 may be provided via the output device 316 of the client computing entity 102. In some embodiments, the user interface 1400 may correspond to the user interface 702 or the user interface 802. In some embodiments, the user interface 802 is an electronic interface that provides a display and/or a visualization to a user via a user computing device. In some embodiments, the user interface 802 provides a GUI and/or associated GUI wizard (e.g., executable code configured to control a functionality of GUI) that provides one or more interactive interface screens, representations, and/or widgets for interacting with a user. The user interface 802 may be configured to provide, for display to a user, a visualization associated with the composite reward score 504. In some embodiments, the user interface 1400 is configured to render an interactive visualization associated with the composite reward score 504. For example, the user interface 1400 may be configured to render the visualization 1306. In addition or alternatively, the user interface 1400 may be configured to render one or more interactive widgets 1402.

In various embodiments, the visualization 1306 may provide an interactive visualization associated with the composite reward score 504 to initiate a rendering of a script and/or execution of one or more instruction sets associated with a visualization and/or mapping. In some embodiments, the one or more interactive widgets 1402 may be configured to receive user input to generate a request (e.g., the request 710 or the request 810). In various embodiments, the user interface 1400 may be configured as a web portal interface (e.g., a medical provider portal, etc.) for managing allocation of resources and/or managing a resource manufacturing device (e.g., the resource manufacturing device 860). In some embodiments, a user interaction with a particular widget of the one or more interactive widgets 1402 may result in rendering of a new interactive widget and/or a new user interface. In some embodiments, the visualization 806 rendered via the user interface 1400 may provide a rendering of a visualization associated with training dataset during training of the multi-level regression model 410. In some embodiments, one or more portions of the multi-level regression model 410 may be configured based on a user interaction with respect to the visualization 1306 and/or the one or more interactive widgets 1402.

In some embodiments, the visualization 806 is configured to render one or more graphical elements associated with the composite reward score 504. A graphical element may be a formatted version of one or more data objects to provide a visualization and/or human interpretation of data via the user interface 1400. In some embodiments, a graphical element is formatted for transmission via a network (e.g., the network 720), an API, a communication channel, a communication interface, the like, or combinations thereof. In one or more embodiments, a graphical element includes one or more graphical elements and/or one or more textual elements that may be selectable and/or otherwise interacted with via the user interface 1400.

In some embodiments, the user interface 1400 is configured to provide visual data for a script associated with one or more prompts with respect to the user interface 1400. In some embodiments, a visualization associated with a script may be arranged relative to the one or more interactive widgets 1402to enable user input with respect to the script. In some embodiments, the one or more interactive widgets 1402 enable a real-time workflow associated with a script. In this manner, the user interface 1400 may provide an interface between a user and a platform that enables a user to selectively a contribute to the real-time workflow associated with a script.

The user interface 1400 may be specially configured to reduce the time, burden, and processing resources traditionally expended to ingest data from a plurality of data sources and/or the multi-level regression model 410. To do so, the user interface 1400 may arrange an interactive representation relative to a plurality of prepopulated target data type representations and corresponding interactive widgets 1402. The interactive representation and/or the one or more interactive widgets 1402 may be arranged to accommodate small screen sizes, such as mobile devices, laptops, etc., without reducing the efficacy of a reviewing process. This, in turn, allows the performance of traditionally complex data matching operations from a client device with small form factors.

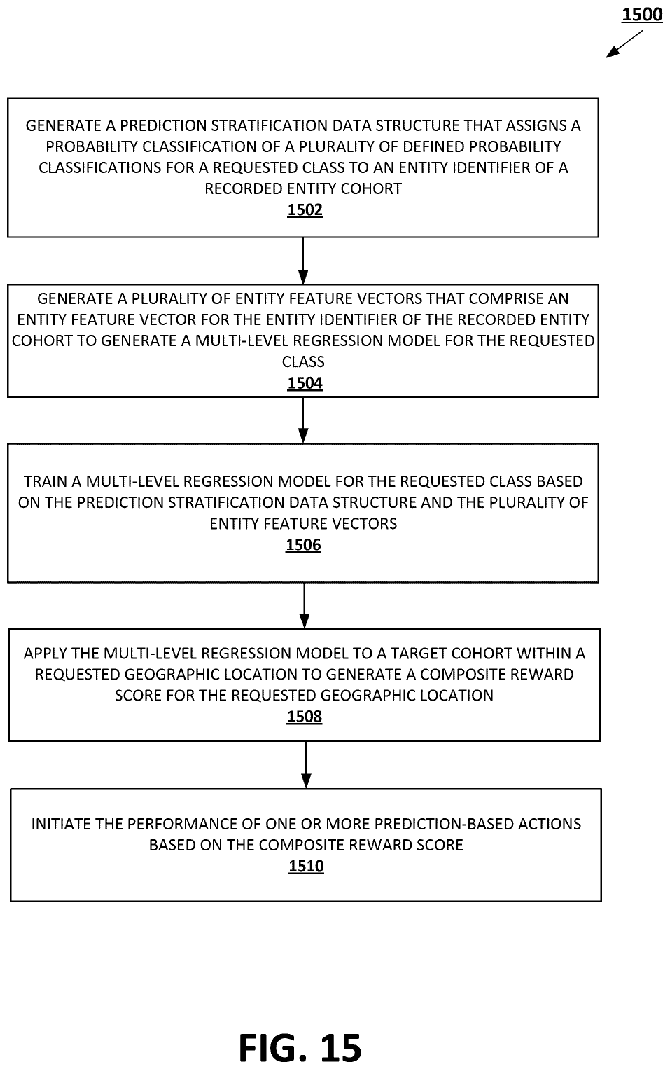

FIG. 15 depicts a flowchart diagram of an example process 1500 for implementing a multi-level regression model in accordance with some embodiments discussed herein. The process 1500 may be executed by one or more computing devices, entities, and/or systems (e.g., the computing system 101 and/or the predictive computing entity 106) described herein. For example, via the various steps/operations of the process 1500, the computing system 101 may leverage improved data pre-processing and/or modeling techniques to optimize an input dataset for a multi-level regression model. By doing so, the process 1500 enables improved prediction-based actions related to a defined modeling task, while ensuring data quality and/or optimized computing resources in view of various data processing and/or modeling rules.

FIG. 15 illustrates an example process 1500 for explanatory purposes. Although the example process 1500 depicts a particular sequence of steps/operations, the sequence may be altered without departing from the scope of the present disclosure. For example, some of the steps/operations depicted may be performed in parallel or in a different sequence that does not materially impact the function of the process 1500. In other examples, different components of an example device or system that implements the process 1500 may perform functions at substantially the same time or in a specific sequence.

In some embodiments, the process 1500 comprises, at step/operation 1502, generating a prediction stratification data structure that assigns a probability classification of a plurality of defined probability classifications for a requested class to an entity identifier of a recorded entity cohort. For example, the plurality of defined probability classifications may comprise a first probability classification associated with a first scaling coefficient, a second probability classification associated with a second scaling coefficient, and a third probability classification associated with a third scaling coefficient.

In some embodiments, the process 1500 comprises, at step/operation 1504, generating a plurality of entity feature vectors that comprise an entity feature vector for the entity identifier of the recorded entity cohort to generate a multi-level regression model for the requested class. In some embodiments, the probability classification is the first probability classification in response to a historical indication of the requested class within a historical feature set associated with the entity identifier. In some embodiments, the probability classification is the second probability classification in response to a rule-based positive output, from a rule-based model corresponding to the requested class, based on the historical feature set associated with the entity identifier. In some embodiments, the probability classification is the third probability classification in response to a machine-learned positive output, from a machine learned model corresponding to the requested class, based on the historical feature set associated with the entity identifier. In some embodiments, the prediction stratification data structure comprises an entity stratification table comprising a training entry for the entity identifier that comprises a probability classification flag for each of the plurality of defined probability classifications.

In some embodiments, the process 1500 comprises, at step/operation 1506, training a multi-level regression model for the requested class based on the prediction stratification data structure and the plurality of entity feature vectors. For example, the prediction stratification data structure and the plurality of entity feature vectors may be synthesized to generate the multi-level regression model for the requested class. In some embodiments, synthesizing the prediction stratification data structure with the plurality of entity feature vectors comprises augmenting the training entry with the entity feature vector. In some embodiments, synthesizing the prediction stratification data structure with the plurality of entity feature vectors in addition or alternatively comprises training the multi-level regression model based on a correlation between the entity feature vector and the probability classification flag for each of the plurality of defined probability classifications. In some embodiments, the entity feature vector comprises a plurality of independent training parameters and the probability classification flag for each of the plurality of defined probability classifications comprises a plurality of dependent training parameters for the multi-level regression model.

In some embodiments, the process 1500 comprises, at step/operation 1508, applying the multi-level regression model to a target cohort within a requested geographic location to generate a composite reward score for the requested geographic location. For example, the composite reward score may combine a reward score for each probability classification of the plurality of defined probability classifications for the requested class. In some embodiments, the reward score for each probability classification is based on the first scaling coefficient, the second scaling coefficient, and the third scaling coefficient.

In some embodiments, the process 1500 comprises, at step/operation 1510, initiating the performance of one or more prediction-based actions based on the composite reward score. For example, the performance of a prediction-based action for the requested geographic location may be initiated based on the composite reward score.

In some embodiments, generating the composite reward score comprises receiving, from the multi-level regression model, a first stratification prediction for the first probability classification, a second stratification prediction for the second probability classification, and a third stratification prediction for the third probability classification. In some embodiments, generating the composite reward score in addition or alternatively comprises applying the first scaling coefficient to the first stratification prediction to generate a first reward score for the first probability classification. In some embodiments, generating the composite reward score in addition or alternatively comprises applying the second scaling coefficient to the second stratification prediction to generate a second reward score for the second probability classification. In some embodiments, generating the composite reward score in addition or alternatively comprises applying the third scaling coefficient to the third stratification prediction to generate a third reward score for the third probability classification. In some embodiments, generating the composite reward score in addition or alternatively comprises aggregating the first reward score, the second reward score, and the third reward score to generate the composite reward score for the requested geographic location.

In some embodiments, the requested geographic location is one of a plurality of requested geographic locations. Additionally, in some embodiments, the process 1500 in addition or alternatively comprises receiving, via a user interface, a mapping request for a user associated with an input geographic location. In some embodiments, the process 1500 in addition or alternatively comprises receiving a plurality of composite reward scores that comprise the composite reward score and an additional composite reward score for an additional geographic location within a search radius of the input geographic location. In some embodiments, the process 1500 in addition or alternatively comprises inputting the plurality composite reward scores, the input geographic location, the requested geographic location, and the additional geographic location to an optimization model to generate a user route.

In some embodiments, the user interface comprises a mapping interface that reflects a geographic region comprising the input geographic location, the requested geographic location, and the additional geographic location. In some embodiments, the process 1500 in addition or alternatively comprises, responsive to the mapping request, initiating the presentation of a routing overlay to the geographic region that identifies the user route. In some embodiments, the routing overlay further identifies the composite reward score for the requested geographic location and the additional composite reward score for the additional geographic location.

In some embodiments, the composite reward score is generated responsive to a routing request from a user that identifies the requested class and the requested geographic location, and initiating the performance of the prediction-based action for the requested geographic location based on the composite reward score comprises routing the user to the requested geographic location responsive to the composite reward score meeting or exceeding a routing threshold.

In some embodiments, the composite reward score is generated responsive to a manufacturing request from a user that identifies the requested class and the requested geographic location, and initiating the performance of the prediction-based action for the requested geographic location based on the composite reward score comprises, responsive the composite reward score meeting or exceeding a resource limit, transmitting a control instruction to a resource manufacturing device to control a manufacturing level of a resource corresponding to the requested class.

Some techniques of the present disclosure enable the generation of action outputs that may be performed to initiate one or more real world actions to achieve real-world effects. The modeling and scaling techniques of the present disclosure may be used, applied, and/or otherwise leveraged to augment a mapping interface, which may help in the creation and provisioning of messages across computing entities, as well as other downstream tasks such as rendering of a visualization via a user interface. For instance, generative output, using some of the techniques of the present disclosure, may trigger the performance of actions at a client device, such as the display, transmission, and/or the like of data reflective of a visualization. In some embodiments, the visualization may trigger an alert via a user interface.

In some examples, the computing tasks may comprise actions that may be based on a defined domain task. A defined domain task may comprise any environment in which computing systems may be applied to generate a visualization and initiate the performance of computing tasks responsive to a visualization. These actions may cause real-world changes, for example, by controlling a hardware component of a user device or a server device, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

In some embodiments, an action (e.g., a prediction-based action) comprises real-time configuration of a user interface based on the composite reward score to enable a user to consume visual data associated with the geographic location in an interactive manner, where the visual data is tailored based on the composite reward score. In some embodiments, an action (e.g., a prediction-based action) comprises an automated drug manufacturing, routing, and/or storage action. For instance, responsive to composite reward score, the computing system 100 may provide one or more instructions to a resource manufacturing device (e.g., a pharmaceutical manufacturing device, etc.) to cause a development of one or more resources (e.g., one or more pharmaceutical resources, one or more hospital resources, one or more medications, etc.). In some examples, the one or more instructions may be tailored to the geographic location. In some embodiments, an action (e.g., a prediction-based action) comprises providing input to an optimization model based on the composite reward score to identify, for example, one or more geographic locations for allocating resources (e.g., allocating pharmaceutical resources, hospital resources, medications, etc.).

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model's architecture and/or their configuration/order, such as the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform all of the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising: synthesizing, by one or more processors, (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class; applying, by the one or more processors, the multi-level regression model to a target cohort within a requested geographic location to generate a composite reward score for the requested geographic location, wherein the composite reward score combines a reward score for each probability classification of the plurality of defined probability classifications for the requested class; and initiating, by the one or more processors, the performance of a prediction-based action for the requested geographic location based on the composite reward score.

Example 2. The computer-implemented method of example 1, wherein the plurality of defined probability classifications comprise a first probability classification associated with a first scaling coefficient, a second probability classification associated with a second scaling coefficient, and a third probability classification associated with a third scaling coefficient and the reward score for each probability classification is based on the first scaling coefficient, the second scaling coefficient, and the third scaling coefficient.

Example 3. The computer-implemented method of any of the above examples, wherein: (i) the probability classification is the first probability classification in response to a historical indication of the requested class within a historical feature set associated with the entity identifier, (ii) the probability classification is the second probability classification in response to a rule-based positive output, from a rule-based model corresponding to the requested class, based on the historical feature set associated with the entity identifier, or (iii) the probability classification is the third probability classification in response to a machine-learned positive output, from a machine learned model corresponding to the requested class, based on the historical feature set associated with the entity identifier.

Example 4. The computer-implemented method of any of the above examples, wherein generating the composite reward score comprises: receiving, from the multi-level regression model, a first stratification prediction for the first probability classification, a second stratification prediction for the second probability classification, and a third stratification prediction for the third probability classification; applying the first scaling coefficient to the first stratification prediction to generate a first reward score for the first probability classification; applying the second scaling coefficient to the second stratification prediction to generate a second reward score for the second probability classification; applying the third scaling coefficient to the third stratification prediction to generate a third reward score for the third probability classification; and aggregating the first reward score, the second reward score, and the third reward score to generate the composite reward score for the requested geographic location.

Example 5. The computer-implemented method of any of the above examples, wherein the prediction stratification data structure comprises an entity stratification table comprising a training entry for the entity identifier that comprises a probability classification flag for each of the plurality of defined probability classifications, and synthesizing the prediction stratification data structure with the plurality of entity feature vectors comprises: augmenting the training entry with the entity feature vector; and training the multi-level regression model based on a correlation between the entity feature vector and the probability classification flag for each of the plurality of defined probability classifications.

Example 6. The computer-implemented method of any of the above examples, wherein the entity feature vector comprises a plurality of independent training parameters and the probability classification flag for each of the plurality of defined probability classifications comprises a plurality of dependent training parameters for the multi-level regression model.

Example 7. The computer-implemented method of any of the above examples, wherein the requested geographic location is one of a plurality of requested geographic locations and the computer-implemented method further comprises: receiving, via a user interface, a mapping request for a user associated with an input geographic location; receiving a plurality of composite reward scores that comprise the composite reward score and an additional composite reward score for an additional geographic location within a search radius of the input geographic location; and inputting the plurality composite reward scores, the input geographic location, the requested geographic location, and the additional geographic location to an optimization model to generate a user route.

Example 8. The computer-implemented method of any of the above examples, wherein the user interface comprises a mapping interface that reflects a geographic region comprising the input geographic location, the requested geographic location, and the additional geographic location, and the computer-implemented method further comprises: responsive to the mapping request, initiating the presentation of a routing overlay to the geographic region that identifies the user route.

Example 9. The computer-implemented method of any of the above examples, wherein the routing overlay further identifies the composite reward score for the requested geographic location and the additional composite reward score for the additional geographic location.

Example 10.The computer-implemented method of any of the above examples, wherein the composite reward score is generated responsive to a routing request from a user that identifies the requested class and the requested geographic location, and initiating the performance of the prediction-based action for the requested geographic location based on the composite reward score comprises routing the user to the requested geographic location responsive to the composite reward score meeting or exceeding a routing threshold.

Example 11.The computer-implemented method of any of the above examples, wherein the composite reward score is generated responsive to a manufacturing request from a user that identifies the requested class and the requested geographic location, and initiating the performance of the prediction-based action for the requested geographic location based on the composite reward score comprises, responsive the composite reward score meeting or exceeding a resource limit, transmitting a control instruction to a resource manufacturing device to control a manufacturing level of a resource corresponding to the requested class.

Example 12.A system comprising: one or more processors; and one or more memories storing processor-executable instructions that, when executed by the one or more processors, cause the one or more processors to perform operations comprising: synthesizing (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class; applying the multi-level regression model to a target cohort within a requested geographic location to generate a composite reward score for the requested geographic location, wherein the composite reward score combines a reward score for each probability classification of the plurality of defined probability classifications for the requested class; and initiating the performance of a prediction-based action for the requested geographic location based on the composite reward score.

Example 13.The system of example 12, wherein the plurality of defined probability classifications comprise a first probability classification associated with a first scaling coefficient, a second probability classification associated with a second scaling coefficient, and a third probability classification associated with a third scaling coefficient, and the reward score for each probability classification is based on the first scaling coefficient, the second scaling coefficient, and the third scaling coefficient.

Example 14.The system of any of the above examples, wherein: (i) the probability classification is the first probability classification in response to a historical indication of the requested class within a historical feature set associated with the entity identifier, (ii) the probability classification is the second probability classification in response to a rule-based positive output, from a rule-based model corresponding to the requested class, based on the historical feature set associated with the entity identifier, or (iii) the probability classification is the third probability classification in response to a machine-learned positive output, from a machine learned model corresponding to the requested class, based on the historical feature set associated with the entity identifier.

Example 15.The system of any of the above examples, wherein the one or more processors further perform operations comprising: receiving, from the multi-level regression model, a first stratification prediction for the first probability classification, a second stratification prediction for the second probability classification, and a third stratification prediction for the third probability classification; applying the first scaling coefficient to the first stratification prediction to generate a first reward score for the first probability classification; applying the second scaling coefficient to the second stratification prediction to generate a second reward score for the second probability classification; applying the third scaling coefficient to the third stratification prediction to generate a third reward score for the third probability classification; and aggregating the first reward score, the second reward score, and the third reward score to generate the composite reward score for the requested geographic location.

Example 16.The system of any of the above examples, wherein the prediction stratification data structure comprises an entity stratification table comprising a training entry for the entity identifier that comprises a probability classification flag for each of the plurality of defined probability classifications, and the one or more processors further perform operations comprising: augmenting the training entry with the entity feature vector; and training the multi-level regression model based on a correlation between the entity feature vector and the probability classification flag for each of the plurality of defined probability classifications.

Example 17.The system of any of the above examples, wherein the entity feature vector comprises a plurality of independent training parameters and the probability classification flag for each of the plurality of defined probability classifications comprises a plurality of dependent training parameters for the multi-level regression model.

Example 18.The system of any of the above examples, wherein the requested geographic location is one of a plurality of requested geographic locations and the one or more processors further perform operations comprising: receiving, via a user interface, a mapping request for a user associated with an input geographic location; receiving a plurality of composite reward scores that comprise the composite reward score and an additional composite reward score for an additional geographic location within a search radius of the input geographic location; and inputting the plurality composite reward scores, the input geographic location, the requested geographic location, and the additional geographic location to an optimization model to generate a user route.

Example 19.The computer-implemented method of any of the above examples, wherein the user interface comprises a mapping interface that reflects a geographic region comprising the input geographic location, the requested geographic location, and the additional geographic location, and the one or more processors further perform operations comprising: responsive to the mapping request, initiating the presentation of a routing overlay to the geographic region that identifies the user route.

Example 20.One or more non-transitory computer-readable media storing processor-executable instructions that, when executed by one or more processors, cause the one or more processors to perform operations comprising: synthesizing (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class; applying the multi-level regression model to a target cohort within a requested geographic location to generate a composite reward score for the requested geographic location, wherein the composite reward score combines a reward score for each probability classification of the plurality of defined probability classifications for the requested class; and initiating the performance of a prediction-based action for the requested geographic location based on the composite reward score

Example 21. The computer-implemented method of example 1, wherein the method further comprises training the multi-level regression model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 12, wherein the one or more processors are further configured to train the multi-level regression model.

Example 25. The computing system of example 24, wherein the one or more processors are comprised in a first computing entity; and the multi-level regression is trained by one or more other processors comprised in a second computing entity.

Example 26. The one or more non-transitory computer-readable storage media of example 20, wherein the instructions further cause the one or more processors to train the multi-level regression model.

Example 27. The one or more non-transitory computer-readable storage media of example 26, wherein the one or more processors are comprised in a first computing entity; and the multi-level regression model is trained by one or more other processors comprised in a second computing entity.

1. A computer-implemented method comprising:
synthesizing, by one or more processors, (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class;
applying, by the one or more processors, the multi-level regression model to a target cohort within a requested geographic location to generate a composite reward score for the requested geographic location, wherein the composite reward score combines a reward score for each probability classification of the plurality of defined probability classifications for the requested class; and
initiating, by the one or more processors, the performance of a prediction-based action for the requested geographic location based on the composite reward score.

2. The computer-implemented method of claim 1, wherein the plurality of defined probability classifications comprise a first probability classification associated with a first scaling coefficient, a second probability classification associated with a second scaling coefficient, and a third probability classification associated with a third scaling coefficient and the reward score for each probability classification is based on the first scaling coefficient, the second scaling coefficient, and the third scaling coefficient.

3. The computer-implemented method of claim 2, wherein:
(i) the probability classification is the first probability classification in response to a historical indication of the requested class within a historical feature set associated with the entity identifier,
(ii) the probability classification is the second probability classification in response to a rule-based positive output, from a rule-based model corresponding to the requested class, based on the historical feature set associated with the entity identifier, or
(iii) the probability classification is the third probability classification in response to a machine-learned positive output, from a machine learned model corresponding to the requested class, based on the historical feature set associated with the entity identifier.

4. The computer-implemented method of claim 2, wherein generating the composite reward score comprises:
receiving, from the multi-level regression model, a first stratification prediction for the first probability classification, a second stratification prediction for the second probability classification, and a third stratification prediction for the third probability classification;
applying the first scaling coefficient to the first stratification prediction to generate a first reward score for the first probability classification;
applying the second scaling coefficient to the second stratification prediction to generate a second reward score for the second probability classification;
applying the third scaling coefficient to the third stratification prediction to generate a third reward score for the third probability classification; and
aggregating the first reward score, the second reward score, and the third reward score to generate the composite reward score for the requested geographic location.

5. The computer-implemented method of claim 1, wherein the prediction stratification data structure comprises an entity stratification table comprising a training entry for the entity identifier that comprises a probability classification flag for each of the plurality of defined probability classifications, and synthesizing the prediction stratification data structure with the plurality of entity feature vectors comprises:
augmenting the training entry with the entity feature vector; and
training the multi-level regression model based on a correlation between the entity feature vector and the probability classification flag for each of the plurality of defined probability classifications.

6. The computer-implemented method of claim 5, wherein the entity feature vector comprises a plurality of independent training parameters and the probability classification flag for each of the plurality of defined probability classifications comprises a plurality of dependent training parameters for the multi-level regression model.

7. The computer-implemented method of claim 1, wherein the requested geographic location is one of a plurality of requested geographic locations and the computer-implemented method further comprises:
receiving, via a user interface, a mapping request for a user associated with an input geographic location;
receiving a plurality of composite reward scores that comprise the composite reward score and an additional composite reward score for an additional geographic location within a search radius of the input geographic location; and
inputting the plurality composite reward scores, the input geographic location, the requested geographic location, and the additional geographic location to an optimization model to generate a user route.

8. The computer-implemented method of claim 7, wherein the user interface comprises a mapping interface that reflects a geographic region comprising the input geographic location, the requested geographic location, and the additional geographic location, and the computer-implemented method further comprises:
responsive to the mapping request, initiating the presentation of a routing overlay to the geographic region that identifies the user route.

9. The computer-implemented method of claim 8, wherein the routing overlay further identifies the composite reward score for the requested geographic location and the additional composite reward score for the additional geographic location.

10. The computer-implemented method of claim 1, wherein the composite reward score is generated responsive to a routing request from a user that identifies the requested class and the requested geographic location, and initiating the performance of the prediction-based action for the requested geographic location based on the composite reward score comprises routing the user to the requested geographic location responsive to the composite reward score meeting or exceeding a routing threshold.

11. The computer-implemented method of claim 1, wherein the composite reward score is generated responsive to a manufacturing request from a user that identifies the requested class and the requested geographic location, and initiating the performance of the prediction-based action for the requested geographic location based on the composite reward score comprises, responsive the composite reward score meeting or exceeding a resource limit, transmitting a control instruction to a resource manufacturing device to control a manufacturing level of a resource corresponding to the requested class.

12. A system comprising:
one or more processors; and
one or more memories storing processor-executable instructions that, when executed by the one or more processors, cause the one or more processors to perform operations comprising:
synthesizing (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class;
applying the multi-level regression model to a target cohort within a requested geographic location to generate a composite reward score for the requested geographic location, wherein the composite reward score combines a reward score for each probability classification of the plurality of defined probability classifications for the requested class; and
initiating the performance of a prediction-based action for the requested geographic location based on the composite reward score.

13. The system of claim 12, wherein the plurality of defined probability classifications comprise a first probability classification associated with a first scaling coefficient, a second probability classification associated with a second scaling coefficient, and a third probability classification associated with a third scaling coefficient, and the reward score for each probability classification is based on the first scaling coefficient, the second scaling coefficient, and the third scaling coefficient.

14. The system of claim 13, wherein:
(i) the probability classification is the first probability classification in response to a historical indication of the requested class within a historical feature set associated with the entity identifier,
(ii) the probability classification is the second probability classification in response to a rule-based positive output, from a rule-based model corresponding to the requested class, based on the historical feature set associated with the entity identifier, or
(iii) the probability classification is the third probability classification in response to a machine-learned positive output, from a machine learned model corresponding to the requested class, based on the historical feature set associated with the entity identifier.

15. The system of claim 13, wherein the one or more processors further perform operations comprising:
receiving, from the multi-level regression model, a first stratification prediction for the first probability classification, a second stratification prediction for the second probability classification, and a third stratification prediction for the third probability classification;
applying the first scaling coefficient to the first stratification prediction to generate a first reward score for the first probability classification;
applying the second scaling coefficient to the second stratification prediction to generate a second reward score for the second probability classification;
applying the third scaling coefficient to the third stratification prediction to generate a third reward score for the third probability classification; and
aggregating the first reward score, the second reward score, and the third reward score to generate the composite reward score for the requested geographic location.

16. The system of claim 12, wherein the prediction stratification data structure comprises an entity stratification table comprising a training entry for the entity identifier that comprises a probability classification flag for each of the plurality of defined probability classifications, and the one or more processors further perform operations comprising:
augmenting the training entry with the entity feature vector; and
training the multi-level regression model based on a correlation between the entity feature vector and the probability classification flag for each of the plurality of defined probability classifications.

17. The system of claim 16, wherein the entity feature vector comprises a plurality of independent training parameters and the probability classification flag for each of the plurality of defined probability classifications comprises a plurality of dependent training parameters for the multi-level regression model.

18. The system of claim 1, wherein the requested geographic location is one of a plurality of requested geographic locations and the one or more processors further perform operations comprising:
receiving, via a user interface, a mapping request for a user associated with an input geographic location;
receiving a plurality of composite reward scores that comprise the composite reward score and an additional composite reward score for an additional geographic location within a search radius of the input geographic location; and
inputting the plurality composite reward scores, the input geographic location, the requested geographic location, and the additional geographic location to an optimization model to generate a user route.

19. The computer-implemented method of claim 18, wherein the user interface comprises a mapping interface that reflects a geographic region comprising the input geographic location, the requested geographic location, and the additional geographic location, and the one or more processors further perform operations comprising:
responsive to the mapping request, initiating the presentation of a routing overlay to the geographic region that identifies the user route.

20. One or more non-transitory computer-readable media storing processor-executable instructions that, when executed by one or more processors, cause the one or more processors to perform operations comprising:
synthesizing (i) a prediction stratification data structure that assigns a probability classification of a plurality of defined probability classifications for a requested class to an entity identifier of a recorded entity cohort with a (ii) a plurality of entity feature vectors that comprise an entity feature vector for the entity identifier of the recorded entity cohort to generate a multi-level regression model for the requested class;
applying the multi-level regression model to a target cohort within a requested geographic location to generate a composite reward score for the requested geographic location, wherein the composite reward score combines a reward score for each probability classification of the plurality of defined probability classifications for the requested class; and
initiating the performance of a prediction-based action for the requested geographic location based on the composite reward score.
